(19) United States
(12) Patent Application Publication
(10) Pub. No.: US 2007/0121632 A1
(43) Pub. Date: May 31, 2007

(54) Method and system for routing an IP packet

(75) Inventor: Boris Zabarski, Tel Aviv (IL)

Correspondence Address: Eitan Law Group;C/O LandonIP Inc., 1700 Diagonal Road, Suite 450, Alexandria, VA, 22314, US

(73) Assignee: Arabella Software, Ltd., Kfar-Saba (IL)

(21) Appl. No.: 11/288,861

(22) Filed: Nov. 28, 2005

(51) Int. Cl. H04L 12/56; H04L 12/28

(52) U.S. Cl. 370/392; 370/395.32

(57) ABSTRACT

Method for generating and thereafter updating a data structure used for routing Internet protocol data packets. Routing a packet is performed by using a destination address of the packet and an updatable set of prefix rules. A prefix rule may be added to a first-level table if the terminating level of the prefix rule equals one. Otherwise, cascading tables may be created until reaching a terminating table for the prefix rule. Then, the prefix rule may be added to its terminating table. The data structure is updateable. The packet routing may be guided by associating one or more fields, or partial fields, of the most significant bits of a destination address of the packet with respective records of search tables, and using the last visited port identifier for routing there through the packet. The data structure is generated by a control processor and stored in a system memory, whereas a network processor searches in the data structure for a prefix rule suitable for each received packet. Searches and updates may be performed substantially at the same time.

### FIELD OF THE DISCLOSURE

The present disclosure generally relates to the field of data networks. More specifically, the present disclosure relates to a method, apparatus and system for generating a routing data structure and for routing an Internet Protocol (“IP”) data packet using the routing data structure.

### BACKGROUND

The Internet infrastructure consists, among other things, of gateways, routers, switches and the like (hereinafter collectively referred to as ‘router’). In general, a router receives a data packet via an input port and forwards it to the destination specified in the packet via an output port of the router. The output port is typically selected according to the destination address specified in the data packet.

An Internet Protocol (“IP”) address is a unique number that devices implementing the Internet Protocol IP use in order to identify each other on a network. Any participating device—including routers, computers, time-servers, FAX machines, and some telephones—must have its own address. This allows information passed onwards on behalf of the sender to indicate where to send it next, and for the receiver of the information to know that it is the intended destination.

The numbers used in IP addresses range from 0.0.0.0 to 255.255.255.255, though some of these values are reserved for specific purposes. This does not provide enough possibilities for every internet device to have its own permanent number, and the Dynamic Host Configuration Protocol (“DHCP”) gives clients dynamic IP addresses that are recycled when they are no longer in use. Systems such as network printers, web servers and e-mail servers are permanently connected to the internet—so they are generally allocated static IP addresses which consistently identify the machine every time it is online. IP addresses are conceptually similar to phone numbers, except that they are used in Local Area Network (LANs), Wide Area Network (“WANs”), and the Internet.

Usually, the destination address has a hierarchical structure, which means that a destination address has an internal structure that can be used to process the address in a manner that depends on the specific communication protocol used. Hierarchical addresses are used in a variety of Internet protocols such as IPv4 and IPv6, which are more fully described at the IETF RFC 719 (“Internet Engineering Task Force”, “Request for Comments”). IPv4 uses 32-bit addresses, limiting it to 4,294,967,296 unique addresses, many of which are reserved for special purposes such as local networks or multicast addresses, reducing the number of addresses that can be allocated as public Internet addresses. As the number of addresses available is consumed, an Pv4 address shortage appears to be inevitable in the long run. This limitation has helped stimulate the push towards IPv6, which is currently in the early stages of deployment, and may eventually replace IPv4.

IPv4 addresses are commonly expressed as a dotted quad, four octets (8 bits) separated by periods. IPv4 addresses were originally divided into two parts: the network and the host. A later change increased that to three parts: the network, the subnetwork, and the host, in that order. However, with the advent of classless inter-domain routing (“CIDR”), this distinction is no longer meaningful, and the address can have an arbitrary number of levels of hierarchy. Forwarding a data packet in a data network involves address lookup in a routing table. Various methods and devices for forwarding packets are described, in U.S. Pat. No. 5,920,886, U.S. Pat. No. 5,938,736 and U.S. Pat. No. 5,953,312, for example.

Typically, a routing table does not contain the entire range of possible destination addresses, but has a set of address prefix rules, typically in the form of binary strings, each of which may represent a group of destinations that are reachable via a common output port. Each prefix rule is, thus, associated with a respective output port (also known as the ‘output link’ and ‘next hop’). Prefix rules may have different length, and packets are typically forwarded to their destination based on a selected group of destination addresses that are represented by the longest prefix matching the destination addresses. Put differently, using a prefix rule means that the longest (most specific) IP (Internet protocol) prefix rule matching the destination address decides to which output port (in the router) the data packet should be sent. Once the longest prefix rule is found, the packet is sent to the output port associated with that prefix rule.

With the proliferation of the Internet and the need to handle an increasing number of data packets that traverse the Internet, high-speed scalable network routers have become a necessity. In other words, fast networking requires fast routers, and fast routers require fast routing table lookups. However, the speed at which a router can route packets is limited by the time it takes it to perform a table lookup for each incoming packet, which time largely depends on the size of the routing table(s) and the search algorithm employed.

Use of longest prefix rule based routing has become popular because it allows using relatively smaller router tables and renders these tables more manageable. Put otherwise, by using longest prefix based routing, the size of routing tables may be kept relatively small and information about changes relating to the additions and removal of hosts and routers need not be propagated through the Internet.

Accordingly, the IP lookup problem has been effectively reduced to the problem of finding the longest matching prefix as fast as possible and while using the smartnest or most reasonable memory size, a problem to which several solutions have been proposed. In general, the complexity of longest prefix matching algorithms, or schemes, encompasses several factors. A first factor is the number of memory accesses per lookup. Other factors refer to the ease of updating the routing (lookup) table(s), which generally refers to a system that is capable of updating a routing table and performing prefix rules lookups substantially at the same time, substantially regardless of one another. Another important factor in performing table lookups is the processing speed, namely the number of processor cycles required per table lookup. Additional important factor is the lookup solution's cost: the cheaper the hardware used for a specific lookup solution, and the smaller the number of memory accesses, the better.

Several longest prefix rule based search schemes have been proposed, which involve use of different types of data structures. For example, a technique known as BSD kernel has been proposed, according to which the table lookup is done using what is known in the art as a compressed binary trie. A more complete explanation of a compressed binary trie can be found, for example, at “An experimental study of compression methods for dynamic tries” (by Stefan Nilson, Helsinki University of Technology, and Matti Tikkanen, Nokia Telecommunications), and at “Summary Structure for Frequency Queries on Large Transaction Sets” (by Dow-Yung Yang, Akshay Johar, Anath Grama and Wojciech Szpankowski, Computer Science Department, Purdue University, West Lafayette, Ind. 47907). Another scheme known as dynamic prefix tries has been proposed by Doeringer. Degermark has proposed a three-level tree structure for routing tables. Using three-level tree structure, IPv4 lookups require, at most, twelve memory accesses. A data structure called the Lulea scheme is essentially a three-level fixed-stride trie in which the nodes are compressed using a bitmap. The multibit trie data structures of Srinivasan and Varghese are considered to be relatively flexible and effective for IP lookup. Another technique called controlled prefix expansion tries of a predetermined height may be constructed for any prefix set. Additional information regarding various address lookup techniques may be found in “Online IP Lookup Techniques Tutorial”, by Wu Yu (Computing Department of Lancaster University, website www.lancs.ac.uk). However, the search techniques referred to hereinabove, and others, have drawbacks that relate either to the number of memory accesses per table lookup or to the management of the search tables, or both.

The concept of longest prefix match (“LPM”) and “Prefix Rules” will be now demonstrated in connection with Table-1. By “prefix” is generally meant a sequence of successive most significant bits (“MSBs”) in a destination address. The prefix may include one bit (for example 1* or 0*), two bits (for example 10* or 11*), three bits (for example 101*, such as rule 2 in Table-1, or 110*, such as rule 3 in Table-1), and so on, where the mark * designates “do not care” bits, the number of which corresponds to the fixed addres length of the destination address. For example, if a destination address is, say, 5-bit long (for example) and the prefix is 1111*, then, ‘*’ stands for one ‘do not care’ bit, wich might be ‘0’ or ‘1’, that is a complimentary bit. If, accoridng to another example, the frefix is 101* (for example), then, given the same 5-bit long address, ‘*’ stands for two complimentary don't care bits, which might be ‘00’, ‘01’, ‘10’ or ‘11’.

TABLE 1

| | | Port Identifier |
|---|---|---|
| | | (Next hop/ |
| Rule # | Prefix Rule | Output link) |
| 1 | *(default rule) | 25 (default output |
| | | port) |
| 2 | 101* | 12 |
| 3 | 110* | 15 |
| 4 | 10111* | 18 |

As shown in Table-1, a packet having a destination address (“DA”) which equals 0.0.240.2 should be forwarded to output port 25 (according to prefix rule #1 in Table-1) because its binary representation is 00000000.00000000.11110000.00000010 and the other prefix rules in Table-1 start with “1”. Likewise, a packet intended for DA 160.3.3.3 should be forwarded to output port 12 (according to prefix rule 2, in Table-1) because its binary representation is 10100000.00000011.00000011.00000011. It is noted that, although the prefix ‘101’ is common to both addresses 160.3.3.3 and 184.160.1.1, the packet destined to address 184.160.1.1 is to be sent to output port 18 and not to output port 12 because the prefix 10111* is longer than the prefix 101*. In general, if there are several prefix rules that match a destination address of a packet, the packet should be sent to the output port associated with the longest prefix rule.

In general, a popular implementation of prefix rules involves using binary tries or multibit tries. A trie is a tree-based data structure that typically consists of several search levels arranged in a hierarchical manner and interconnected by search branches. A “branch” is a logical link or association between two nodes. One node may belong to one search level and another node may belong to one upper, or lower, search level. Accordingly, searching for a prefix rule often involves going from one node to another, usually along the corresponding branches. Tries allow searching for the longest prefix rule that matches a given destination address and the search is guided by the bits of the destination address. The search typically ends when no more trie branches exist; that is, when a last node is visited and the longest prefix rule may be the prefix rule associated with the last visited node. At times, no prefix rule may be found after reaching the last node. In such cases, there will be a need to go “backwards” (in the opposite direction) one or more levels, where a longest prefix rule is found.

A binary trie generally refer to a binary search tree in which each such level represents a single search bit, and each node may have up to two branches, often referenced to as “sons”, a left son and a right son. The left son may correspond, for example, to the binary value “0” (or to “1”), whereas the right son may correspond to the binary value “1” (or to “0”). Each node in the trie is preferably derived from a corresponding prefix rule.

Searching a binary trie may be rather slow, because one bit at a time is inspected in the worst case, which means that 32 memory accesses may be needed for an IPv4 address. Alternatively, a search operation can be speed-up by inspecting several bits at a time. The number of bits to be inspected is referred to as “stride” and can be constant or variable. A trie allowing inspection of bits in stride of several bits is called herein a “multibit trie”. Search in a multibit trie is essentially the same as search in a binary (1 bit) trie. A multibit-trie is a search tree in which each search level represents multiple address bits, and it is equivalent to multiple levels of binary trie. Each one of the node's sons matches a value of the handled bits. Each pass in the trie exactly matches a prefix value.

Referring now to FIGS. 1 and 2, they show an exemplary binary trie and multibit trie, respectively, that graphically illustrate the examples described in connection with the prefix rules as specified in Table-1. The larger the stride used in a trie, the smaller the number of the search levels necessary, as demonstrated by FIGS. 1 and 2. In respect of the exemplary multibit trie of FIG. 2, each level handles 3 address bits (i.e., 110, 101, 111), all of which is described in more details below.

The longest matching prefix rule may be found as by using address bits one at a time, as exemplified in FIG. 1. For example, If the most significant bit (“MSB”) of a destination address is “1” (for example, as would be in the address 102), then the search continues from a start at the highest (default) node 101 to node 103 in the next, lower, level. Node 103 may have two sons, or branches, one of which being branch 111, for example. If the second MSB of the destination address is “0” (as shown at 104), then a branch 104 is made to a node (105) in the third level. If, however, the second MSB of the destination address is “1” (as shown at 106), the search will be directed to node 107 by branch 111. If, at node 107, the third MSB of the destination address is “0” (as shown at 108), the next node 109 is visited through branch 112, with which port identifier 12 (shown at node 109) is associated. As demonstrated by FIG. 1, branches, for example branches 110, 111 and 112, are created or utilized based on the value of a single bit. Alternatively, a longest matching prefix rule may be found by using three bits at a time, as exemplified in FIG. 2, wherein like numbers denote like items. For example, branching from node 101 to nodes 109 (as along branch 210) and 113 (as along branch 220) will occur if the three MSBs of the destination address are “110” and “101”, respectively.

If a terminating node is reached (for example terminating node 114 of FIGS. 1 and 2, which is reached respectively by branches 115 and 230), then the port identifier associated with its prefix rule is considered the ‘result’ of the search (18, in this example). That is, the port identifier may be the address (or the port identifier may point to a place of the address) of an output port to which the related data packet should be sent. if no port identifier is associated with a terminating node, the search path should ‘backtrack’ ‘upwards’, or ‘backwards’, to a node of a previous level, until reaching the last visited node with which a port identifier has been associated.

More about tries can be found in (i) “Packet Classification Using Two-Dimensional Multibit Tries”, from Wencheng Lu and Sartaj Sahni (Department of Computer and Information Science and Engineering, University of Florida, Gainesville, Fla. 32611, Sep. 21, 2004); (ii) “Efficient Construction of Variable-Stride Multibit Tries for IP Lookup”, from Sartaj Sahni and Kun Suk Kim (Department of Computer and Information Science and Engineering, University of Florida, Gainesville, Fla. 32611, Sep. 21, 2004) and in (iii) “Efficient Construction of Pipelined Multibit-Trie Router-Tables”, from Kun Suk Kim and Sartaj Sahni (Department of Computer and Information Science and Engineering, University of Florida, Gainesville, Fla. 32611, Sep. 21, 2004).

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other advantages or improvements.

During updating of a data structure, a prefix rule may be partitioned into several MSBs fields, from the most significant bit of the rule towards the least significant bit of the rule. A maximum number of bits is specified for each MSBs field in the rule, in accordance with the partitioning of destination addresses. However, it may occur that the last MSBs field (or least significant bits (“LSBs”) field) in a prefix rule will contain a number of bits that is smaller than the maximum number of bits specified for that field. A MSBs field that contains less than its specified maximum number of bits is referred to hereinafter as a partial field.

As part of the disclosure, a method is provided for generating a data structure for routing an Internet protocol data packet. The routing may be performed by using a destination address of the packet and an initial, and thereafter updatable, set of prefix rules. The data structure may initially include at least a first-level table, whose records are initially cleared, and each prefix rule (for example, 1101*→25) is an association between a ‘prefix part’ of the prefix rule (1101, for example) and a port identifier (25, for example) to which a packet should be sent if the packet's destination's address has the associated prefix. The initial set of prefix rules may include one or more prefix rules.

According to some embodiments, the method may include adding a prefix rule to the first-level table if the terminating level of the prefix rule equals one. However, if the terminating level of the prefix rule is greater than one, then one or more cascading tables may be created such that the table that was last created is a terminating table for the prefix rule. Then, the prefix rule may be added to the newly created terminating table.

According to some embodiments, the data structure may be updated by adding additional prefix rules. A terminating table is searched for each additional prefix rule and, unless a terminating table has been found for it (which was previously created for other prefix rule(s)), a terminating table is created for it. According to some embodiments, the update may further include removal of prefix rules.

As part of the present disclosure, a method of routing an Internet protocol packet by use of a routing data structure is provided. According to some embodiments the routing method may include association of a first field of the most significant bits of a destination address of the packet with a record of a first-level-table, wherein the record of the first-level-table may include either a first port identifier and/or a second-level-table identifier. The first port identifier may be used for routing the packet in the absence of a second-level-table identifier.

The routing method may further include associating a second field of the most significant bits of the destination address with a record of a second-level-table identified by the second-level-table identifier, wherein the record of the second-level-table may include either a second port identifier and/or a third-level-table identifier. The second port identifier, or in its absence, the first port identifier, may be used for routing the packet in the absence of a third-level-table identifier.

The routing method may further include associating a third field of the most significant bits of the destination address with a record of a third-level-table identified by the third-level-table identifier, wherein the record of the third-level-table may include either a third port identifier and/or a fourth-level-table identifier. The third port identifier, or in its absence, the second port identifier, or in its absence, the first port identifier, may be used for routing the packet in the absence of a fourth-level-table identifier.

The routing method may further include associating a fourth field of the most significant bits of the destination address to a record of a fourth-level-table identified by the fourth-level-table identifier, wherein the record of the fourth-level-table may include a fourth port identifier. The fourth port identifier, or in its absence, the third port identifier, or in its absence, the second port identifier, or in its absence, the first port identifier, may be for routing the packet.

As part of the present disclosure, an apparatus is provided for routing an Internet protocol packet. According to some embodiments, the apparatus may include a control processor for generating and storing in an external system memory (“ESM”) (‘external’—in respect of the apparatus) a routing data structure that may include at least a first-level table; an input/output port unit for receiving a packet via an input port and forwarding said packet via an output port; one or more direct memory access (“DMA”) engines for allowing an access to data stored in the ESM; and a network processor coupled to the input/output port unit to receive therefrom, and to forward there through, packets. The network processor may forward received packets to the ESM. The network processor may couple to the one or more DMA engines for requesting an access to the ESM for obtaining therefrom at least the packet's header or a portion thereof. The network processor may then extract the destination address from the header, or from a portion thereof, and partition (parsing) the destination address's most significant bits to fields, or partial fields, one field/partial field at a time, for guiding the search in the routing data structure for a port identifier to which the received packet should be sent.

The control processor and network processor may each be equipped with a memory for storing therein instruction codes for running the procedures involved in the generation and update of the routing data structure, and the search through the routing data structure. The memory may be part of the respective processor or it may reside externally to the processors.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustarted in referenced figures. It is intended that the embodiments and figures disclosed herein are to be considered illustrative, rather than restrictive. The disclosure, however, both as to organization and method of operation, together with objects, features, and advantages thereof, may best be understood by reference to the following detailed description when read with the accompanying figures, in which:

FIG. 1 shows an exemplary one-bit search trie scheme;

FIG. 2 shows an exemplary three-bit search trie scheme;

FIG. 3 is an exemplary flowchart for finding a table to which a new rule may be added according to some embodiments of the present disclosure;

FIG. 4 is an exemplary prefix rule addition for adding a new rule to a table found by using the flowchart of FIG. 3;

FIGS. 5a and 5b schematically illustrate an exemplary search/routing data structure before and after adding a new prefix rule, respectively, according to some embodiments of the present disclosure;

FIG. 5c is an exemplary search/routing data structure, according to some embodiments of the present disclosure;

FIG. 6 is an exemplary flowchart for finding a table in a search/routing data structure from which a rule may be removed according to some embodiments of the present disclosure;

FIG. 7 is an exemplary prefix rule removal flowchart for removing a prefix rule from a table that was found by using the flowchart of FIG. 6;

FIG. 8 exemplifies removal of a prefix rule from a search/routing data structure by using the flowcharts of FIGS. 6 and 7;

FIG. 9 is an exemplary prefix rule search flowchart, according to some embodiments of the present disclosure;

FIG. 10 schematically illustrates an exemplary prefix rule search in an exemplary routing data structure; and

FIG. 11 schematically illustrates a general layout and functionality of the system for generating and managing a search/routing data structure according to some embodiments of the present disclosure.

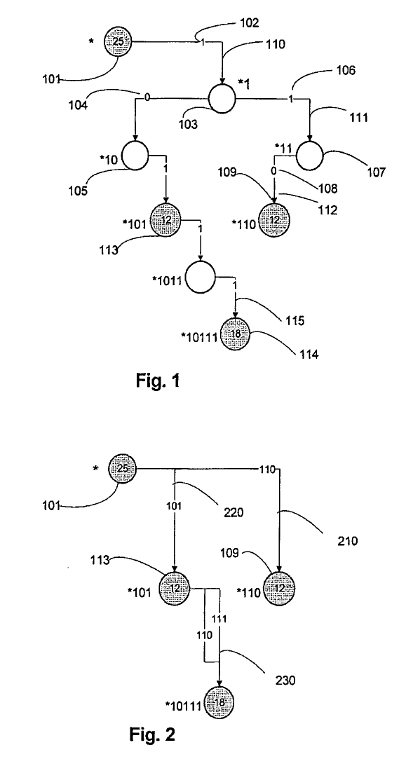

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate like elements.

### DETAILED DESCRIPTION

In the following detailed description, numerous specific details are set forth in order to provide a thorough understanding of the disclosure. However, it will be understood by those skilled in the art that the present disclosure may be practiced without these specific details. In other instances, well-known methods, procedures, components and circuits have not been described in detail so as not to obscure the present disclosure.

Unless specifically stated otherwise, as apparent from the following discussions, it is appreciated that throughout the specification discussions utilizing terms such as “processing”, “computing”, “calculating”, “determining”, “deciding”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present disclosure may include an apparatus for performing the operations described herein. This apparatus may be specialty constructed for the desired purposes, or it may comprise a general-purpose computer selectively activated or reconfigured by a computer program stored in the computer.

Furthermore, the disclosure may take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, transport or the like, a program for use by or in connection with an instruction execution system, apparatus, device, or the like.

The medium may be an electronic, magnetic, optical, electromagnetic, infrared, or semiconductor or the like system (or apparatus or device) or a propagation medium. Examples of a computer-readable medium include a semiconductor or solid state memory, magnetic tape, magnetic-optical disks, a removable computer diskette, a random access memory (RAM), a read-only memory (ROM), a rigid magnetic disk, an optical disk, electrically programmable read-only memories (EPROMs), electrically erasable and programmable read only memories (EEPROMs), magnetic or optical cards, or any other type of media suitable for storing electronic instructions, and preferably capable of being coupled to a computer system bus. Current examples of optical disks include compact disk—read only memory (CD-ROM), compact disk-read/write (CD-R/W) and DVD.

A data processing system suitable for storing and/or executing program code may include at least one processor coupled directly or indirectly to memory elements as through a system bus. The memory elements may include local memory employed during actual execution of the program code, bulk storage, and cache memories which provide temporary storage of at least some program code in order to reduce the number of times a code has to be retrieved from bulk storage during execution, as well as other elements, apparatuses or systems as will occur to one of skill in the art.

Input/output or I/O devices (including but not limited to keyboards, displays, pointing devices, and the like) can be coupled to the system either directly or through intervening I/O controllers.

Network adapters may also be coupled to the system to enable the data processing system to become coupled to other data processing systems or remote printers or storage devices, or the like, through intervening private, public or other networks. Modems, cable modem and Ethernet cards are just a few of the currently available types of available network adapters.

The processes and displays presented herein are not inherently related to any particular computer or other apparatus. Various general-purpose systems may be used with programs in accordance with the teachings herein, or it may prove convenient to construct a more specialized apparatus to perform the desired method(s) or develop the desired system(s). The desired structure(s) for a variety of these systems will appear from the description below. In addition, embodiments of the present disclosure are not described with reference to any particular programming language. It will be appreciated that a variety of programming languages may be used to implement the teachings of the disclosures as described herein.

Unless specifically stated otherwise, the examples, and in general the descriptions given hereinafter, refer to IPv4 protocol packets, the destination addresses of which consist of a fixed number of 32 bits. In addition, unless specifically stated otherwise, the address of an IPv4 packet is partitioned into the following non-limiting exemplary four fields (fields C1 to C4) with the respective non-limiting bit-wise lengths: 12 MSBs (C1), 6 bits (C2), 6 bits (C3) and 8 LSBs (C4). In addition, entries/records of a table, which do not contain, what is called hereinafter as, “next-order table identifier” contain a “Null” pointer, and entries/records of a table, which do not contain, what is called hereinafter as, “port ID identifier”, contain a reserved “invalid” (0) port identifier.

In addition, whenever the word “node” is used hereinafter, it refers to a search table in the data structure. The terms “nodeI” and “levelInode”, which are interchangeably used hereinafter, refer to a search table at level ‘I’ (I=1, 2, 3, . . . , etc). Since, according to the present disclosure, a search table at level I is pointed at by a pointer (“pI”), then, sometimes, a table is simply called, or referred to as, ‘pI’. For example, “p1” means a search table at level 1. The expressions “pI[temp].son” and “nodeI entry.address”, which are interchangeably used hereinafter, refer to a “next-order table identifier” field in an entry whose relative location/address in the table is specified by ‘temp’ (or ‘entry’, whichever the case may be) of a table at level ‘I’. For example, the expressions “node2entry.address” (where ‘entry’ may equal 12, for example) and “p2[12].son” (where temp=12, for example) refer to a directive: “take the third-level table identifier residing within the 12^{th} entry of a second-level table”. The third-level table identifier so obtained may be used as a base address of, or a pointer to, a corresponding third-level table. Similarly, the expression “nodeIentry.portID” refers to the port identifier field in a specific entry of a table at level ‘I’. For example, the expression “node2entry.portID” (where entry may equal 56 and portID may equal 23, for example) refers to a directive: “take the value second-level port identifier (‘23’ in this example) residing within the 56^{th} entry of a second-level table”. The value ‘23’ may then be used as a port, or a pointer to a port, to which a packet may be sent, provided that no other port identifiers were found for that packet. In respect of a given prefix rule, by ‘terminating table’ is meant herein the last table in the search path of the given prefix rule, or, put differently, a ‘terminating table’ is the table containing the port identifier associated with the given prefix rule.

According to some embodiments, the method for generating and continuously updating a data structure for routing Internet protocol packets, that initially includes a first-level table may generally include adding a prefix rule to the first-level table if the terminating level of the prefix rule equals one. If, however, the terminating level of the prefix rule is greater than one, then one or more cascading tables are created, such that the first table is associatively linked to the first-level table and the last table is the terminating table for the prefix rule. Once the terminating table has been created, the prefix rule may be added to the terminating table.

According to some embodiments, creating the one or more cascading tables may include repeatedly creating a next-level table while in each repetition, a corresponding next-level-table identifier may populate a record of the previous-level table, which is pointed at by a corresponding field, or partial field, of the most significant bits the prefix rule, until a terminating table for the prefix rule is created.

According to some embodiments, adding a prefix rule to its terminating table may include populating (inserting into) one or more records of the terminating table with the port identifier (portID) of the prefix rule being added if the prefix rule is the longest prefix rule pertaining to the one or more records. The one or more records are pointed at by the last field, or last partial field, of the most significant bits of the prefix rule being added.

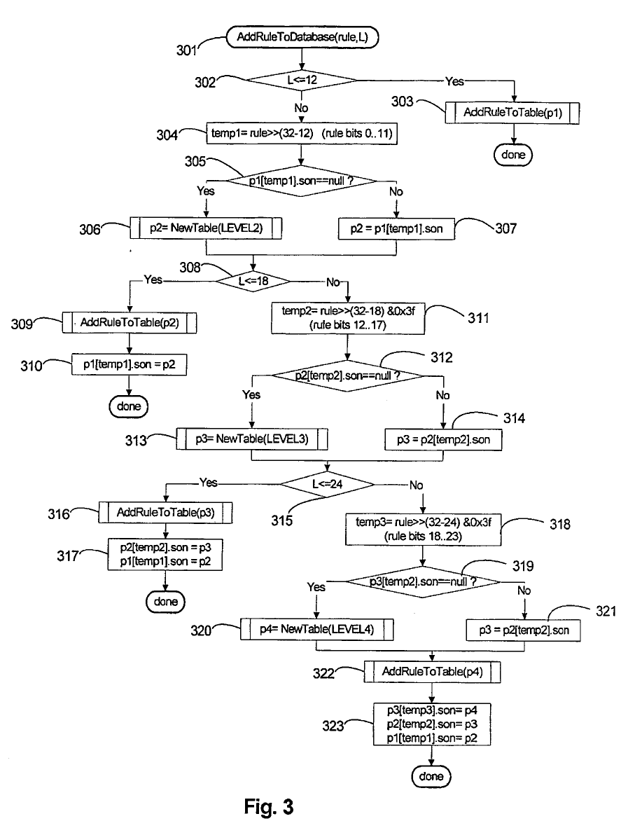

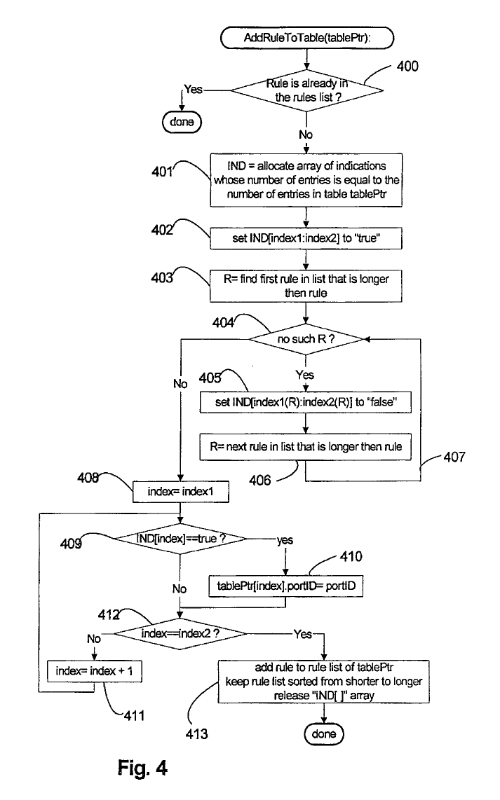

Referring now to FIG. 3, it shows an exemplary flowchart for finding an existing table, or creating a new search table (whichever the case may be), in a routing data structure to which a new rule may be added according to some embodiments. If no data structure exists yet, the data structure may be generated by adding a first prefix rule, and thereafter (if so desired or required) additional prefix rules, one prefix rule after another, in the way described hereinafter. In that sense, there is no practical difference between ‘generation’ of the data structure and ‘addition’ of rules to a data structure, since the data structure is generated by adding prefix rules. The steps involved in the actual addition of the new rule to the found, or newly generated, table is described in connection with FIG. 4. Before a new rule is added to the data structure, a table has first to be found, to which the new rule may be added. If such a table is not found, a new table has first to be created for accommodating the new prefix rule.

Finding or Creating a Search Table Before Adding a New Prefix Rule

The length L{R} of the searched prefix rule R is calculated and the base address of the first-level-table associated with R is known a-priori, at step 301. At step 302, L{R} is compared to 12, the number of 12 MSBs bits, numbered 0 to 11, of R, according to some embodiments.

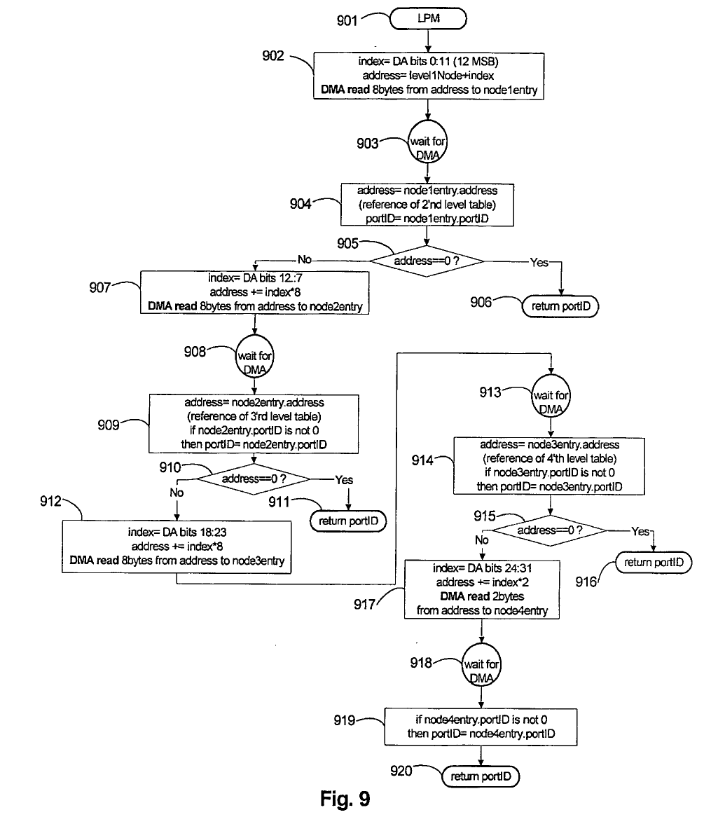

If L{R}≦12, then, at step 303, the search is stopped and the prefix rule (R) is to be added to the first-level-table, in a way exemplified by the flowchart of FIG. 9. It is noted that it is assumed that only prefix rules that are known to be new rules are added to the corresponding table. Of course, if, for some reason, it is not known in advance whether or not a specific rule is new, the rule to be added can be searched for in the corresponding rules list and, if the rule is already contained in the list, no addition thereof will occur. If the rule will not be found in the rules list, it will be assumed that the rule is new and, therefore, it will be added to the corresponding table and list using the exemplary flowchart of FIG. 4

If, however, L{R}>12, this means that L{R} “overflows” to a second-level-table. Therefore, a second-level-table is searched for, which is suitable for R, and, if such a table does not exist, a new, suitable, second-level-table has to be generated. Searching for a suitable second-level-table involves extraction of bits 0 to 11 of R, at step 304; using these 12 bits to address a corresponding record (“REC12”) in the first-level-table and checking, at step 305, the value stored in the second-level-table identifier field of REC12. If the value stored in the second-level-table identifier field of REC12 is Null, which means that no base address of a second-level-table is specified therein, a new second-level-table may be generated, the content of which may be initially cleared, and the base address of which (“p2”) may be stored, at step 306. Otherwise (the value stored in the second-level-table identifier field of REC12 points to, or is the base address of, an existing second-level-table), the base address (p2) of the second-level-table specified in the identifier field of REC12 may be stored, at step 307. P2 may be used later, at step 312, should the need arise.

At step 308, the value of L{R} is compared to 18, the number of bits 12 to 17 of R, according to some embodiments. If L{R}≦18, then, at step 309, the search is stopped and R is to be added to the second-level-table, and, at step 310, the base address (p2) of the newly generated second-level-table is inserted into the second-level-table identifier field of a record in the first-level-table whose address is specified by bits 0 to 11 of R.

If L{Rs}>18, this means that L{R} “overflows” to a third-level-table. Therefore, a third-level-table is searched, which is suitable for R, and, if such a table does riot exist, a new, suitable, third-level-table has to be generated. Searching for a suitable third-level-table involves extraction of bits 12 to 17 of R, at step 311, using these 6 bits to address a corresponding record (“REC23”) in the second-level-table and checking, at step 312, the value stored in the third-level-table identifier field of REC23. If the value stored in the third-level-table identifier field of REC23 is Null; that is, no base address of a third-level-table is specified therein, a new third-level-table is generated, the content of which is initially cleared, and the base address of which (“p3”) is stored, at step 313. Otherwise (a base address p3 of the third-level-table is specified), the content of the third-level-table identifier field of REC23; that is, p3, is stored, at step 314. Base address p3 may be used later, at step 319, should the need arises.

At step 315, the value of L{R} is compared against 24, the number of bits 18 to 23 of R, according to some embodiments. If L{R}≦24, then, at step 316, the search is stopped and R is to be added to the third-level-table, and, at step 317, the base address (p3) of the newly generated third-level-table is inserted into the third-level-table identifier field of a record in the second-level-table whose address is specified by bits 12 to 17 of R. Likewise, if a second-level-table has also been newly generated, its base address (p4) is inserted into the second-level-table identifier field of a record in the first-level-table whose address is specified by bits 0 to 11 of R.

If L{Rs}>24, this means that L{R} “overflows” to a fourth-level-table. Therefore, a fourth-level-table is searched, which is suitable for R, and, if such a table does not exist, a new, suitable, fourth-level-table has to be generated. Searching for a suitable fourth-level-table involves extraction of bits 18 to 23 of R, at step 318, using these 6 bits to address a corresponding record (“REC34”) in the third-level-table and checking, at step 319, the value stored in the fourth-level-table identifier field of REC34. If the value stored in the fourth-level-table identifier field of REC34 is Null; that is, no base address of a fourth-level-table is specified therein, a new fourth-level-table is generated, the content of which is initially cleared, and the base address of which (“p4”) is stored, at step 320. Otherwise (a base address p4 of the fourth-level-table is specified), the content of the fourth-level-table identifier field of REC34; that is, p4, is stored, at step 321.

At step 322, the search is stopped and rule R is to be added to the fourth-level-table, whether it is found (at step 321) or generated (at step 320), and, at step 323, the base address (p4) of the newly generated fourth-level-table is inserted into the fourth-level-table identifier field of a record in the third-level-table whose address is specified by bits 18 to 23 of R. Likewise, if a third-level-table has also been newly generated, its base address (p3) is inserted into the third-level-table identifier field of a record in the second-level-table whose address is specified by bits 12 to 17 of R. Likewise, if a second-level-table has also been newly generated, its base address (p2) is inserted into the second-level-table identifier field of a record in the first-level-table whose address is specified by bits 0 to 11 of R.

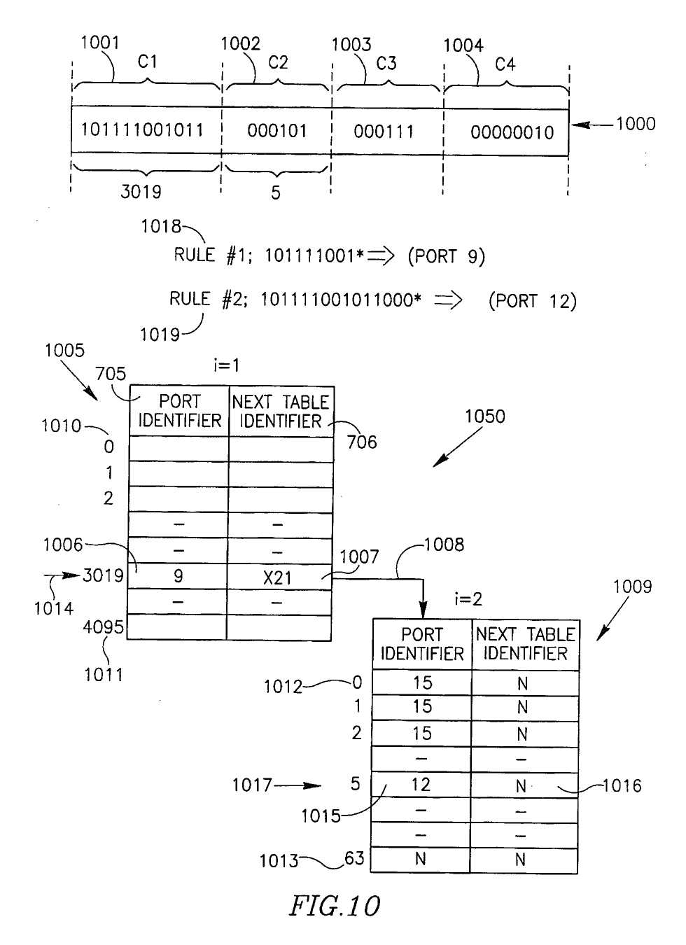

Every time a new table is generated for accommodating for a newly added prefix rule, the new table will have a number of records that depends on the table's level and on the number of bits associated with that level. For example, since according to some embodiments a second-level and third-level table is associated with 6 bits (C2 and C3 of FIG. 10, respectively), a second-level and third-level table will each consist of 2⁶=64 records, whereas a fourth-level table (C4 of FIG. 10) will consist of 2⁸=256, as variously explained hereinbefore. In case a new table is generated, all of its records will be initially cleared by setting all of its binary words to “0”. This way, all of the port identifiers in the table will have an invalid value, and all of the next-order-table identifiers in the table will have a “Null” value. One or more of the initial values may later change as new/exist rules are added/deleted/changed. Once a new table is created, or a decision for its creation is made, a rule list is uniquely created for, and is associated with, that table.

Adding a New Prefix Rule to the Found, or Created, Table

Referring now to FIG. 4, it shows an exemplary prefix rule addition flowchart for adding a prefix rule to a table that was found, or generated, according to the flowchart of FIG. 3. Once a table is found, or a new one generated, whichever the case may be, to which a new prefix rule may be added, an indications array, IND[], is temporarily generated, at step 401, and allocated for the found, or generated, table, respectively. IND[ ] will be generated and allocated only if the prefix rule to be added is not found in the corresponding rules' list (400). The number of entries in IND[] may equal the number of records in the table to which the new rule is added. After completing the addition of the new rule, the temporary array may be erased to save memory space. At step 402, all the entries of IND[] that correspond to the range index1 to index2 (inclusive) of the new rule are initialized with a binary value “1” (“true”), for indicating that each one of a number of respective records in the table, the records being defined by the range index1 to index2 of the newly added rule, is a candidate for accommodation of the newly added rule. A specific record in the table will eventually be reserved for the newly added rule if this record is not currently reserved for, or used by, a longer rule.

Accordingly, at step 403, a first, already existing, rule is sought in the rule list associated with the table, which is longer than the new rule. If such a rule is found in the rule list, at step 404, this means that the content of the records in the table that are used by the longer rule are not to be overridden by the new, shorter, rule. Therefore, in order to ‘protect’ records used by (‘belonging’ to) longer rules from being overridden, entries in IND [], which correspond to the respective records to be protected in the table, are set to binary value “0” (“false”), at step 405. The range of the records to be protected corresponds to, or overlaps, the range defined by index1 to index2 of the longer rule. Then, the next longer rule is sought in the rule list, at step 406, and the ‘protection’ loop 407 repeats while, for each rule in the list that is longer than the rule to be added, the protected records range is defined by the range index1 to index2 of the longer rule.

After exhausting the ‘protection stage’ (loop 407), the next stage is to see which record(s) in the table, which were initially reserved for the new rule (at step 402), has/have remained unprotected. A remaining unprotected record may imply either that the record is either currently used by an existing rule that is shorter than the new rule, in which case the new, longer rule has to override the shorter rule, or that the record is not currently used by any other rule.

In order to identify the records that will be used by the new rule; that is, to identify the unprotected record(s) in the table, the array IND[] is scanned, by incrementing a variable (called ‘index’) by one, at step 411 and, for each value of ‘index’, evaluating the next array's entry, at step 409. Unprotected records will be encountered by identifying remaining “true” values in the array IND[].

Accordingly, at step 408, ‘index’ is initially assigned the value index1 of the new rule, and, at step 409, the value of the corresponding entry (IND[index]) is checked. Whenever the entry's value encountered is “true”, the new rule is added to the respective record in the table, at step 410, by replacing a no-longer relevant port identifier or an “invalid” value in the port identifier field of that record (which ever the case may be) by the new rule's port identifier. If, however, an entry's value is “false”, the array IND[] is further ‘scanned’ by incrementing ‘index’ by one, at step 411, until the condition index=index2 is met, at step 412, where index2 is the other (upper) limit of the records range ‘covered’ by the new rule. Once the new rule is added to the (found or generated) table, the rule is added also to the rules' list associated with that table, at step 413.

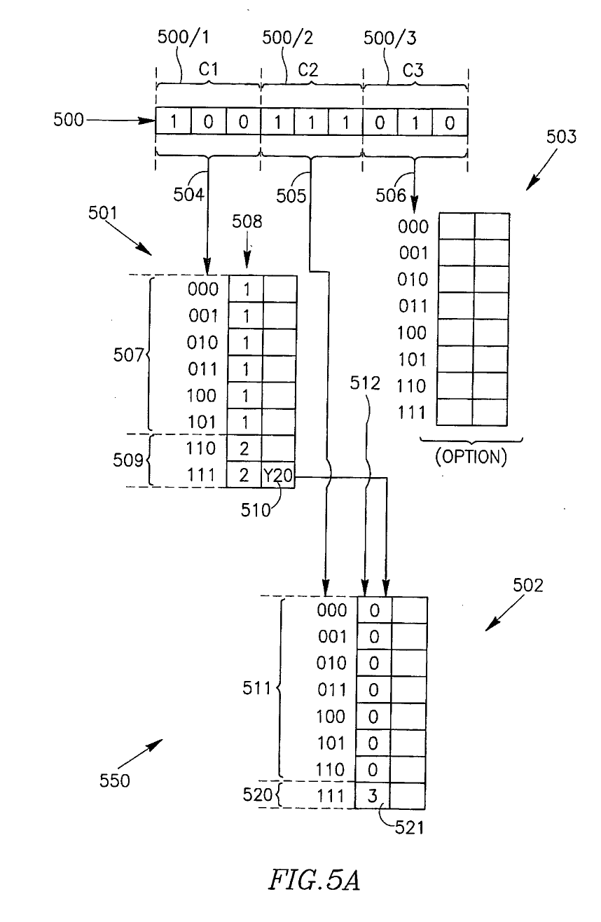

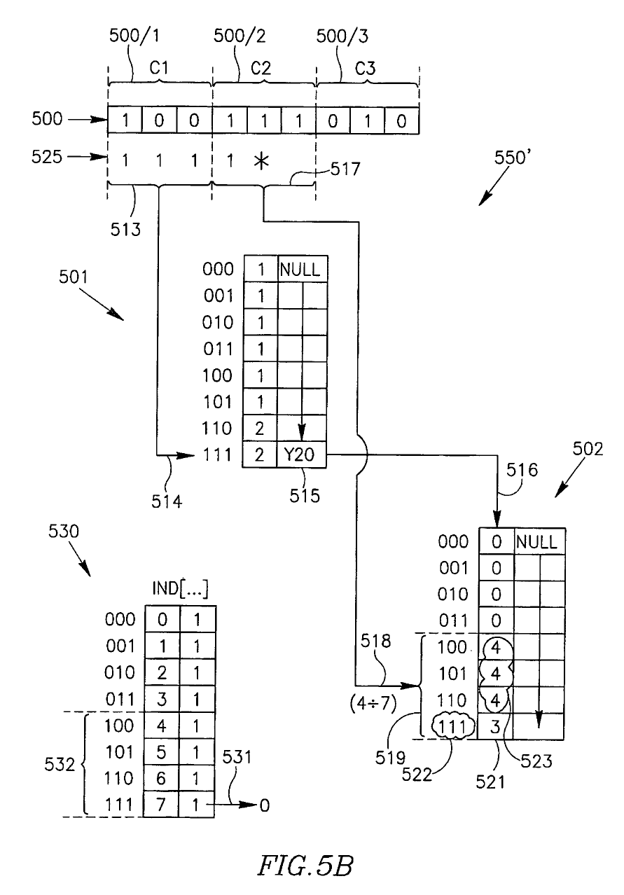

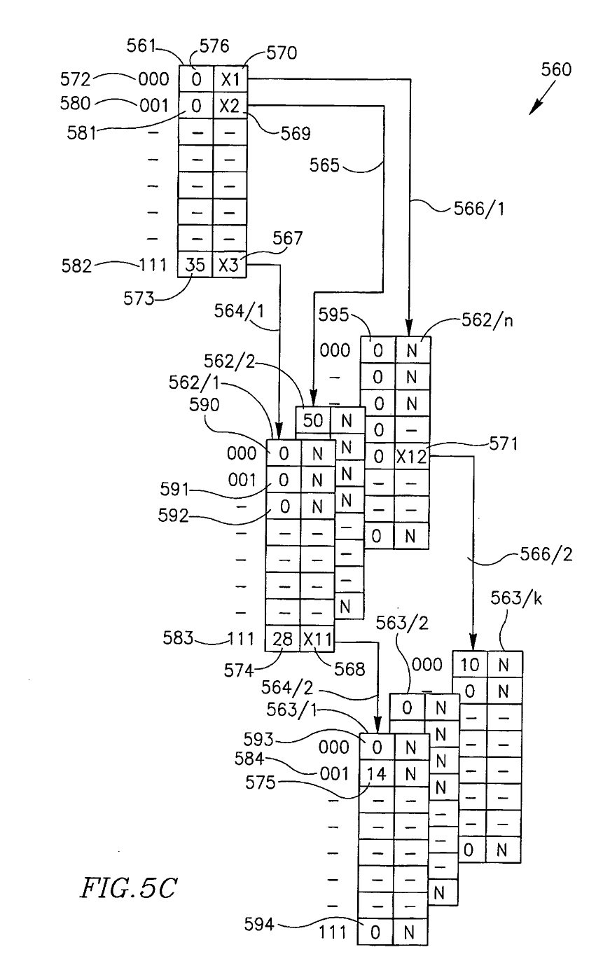

Referring now to FIGS. 5a and 5b, they illustrate an exemplary routing data structure before (550, in FIG. 5a) and after (550′, in FIG. 5b) adding a new prefix rule, respectively. For the sake of simplicity it is assumed that exemplary destination address 500 is a 9-bit long address partitioned into three, equally bit-wise long, field C1 (500/1) to C3 (500/3). Accordingly, the maximum number of bits specified for each MSB field (in this example) is three bits. The three bits of field C1 (500/1) and field C3 (500/3) are, according to the present disclosure, the MSBs and LSBs fields of destination address 500, respectively. However, the LSBs field may be considered as the last MSBs field of the destination address. The binary value contained in field C1 (500/1), field C2 (500/2) and field C3 (500/3) may determine (504, 505 and 506, respectively) the relative location, or address, of a record within a corresponding first-level-table 501, second-level-table 502 and third-level-table 503, respectively, as variously exemplified herein. Since destination address 500 has been partitioned into three fields (C1 to C3), the lowest (or “deepest”) level table(s) possible in this case is third-level-table(s). Since field C1 (500/1) to C3 (500/3) may each contain three binary bits, each one of tables 501 to 503 may have a maximum of 2³=8 entries, or records.

Addition of a prefix rule to an existing search data structure will be exemplified now in conjunction with the set of prefix rules specified in Table-2. It is assumed that a routing data structure (500) already exists, which is based on prefix rules 1 to 3 specified in Table-2. Should a prefix rule be bit-wise longer than 6 bits (‘6’ corresponding to the concatenation of fields C1 (500/1) and C2 (500/2)), a third-level table, such as third-level table 503, may be used for accommodating for that prefix rule, that is, according to this example. It is also assumed that it is desired to add prefix rule number 4 in Table-2 to the exemplary data structure 550.

TABLE 2

| Rule | | Port | | |
|---|---|---|---|---|
| number | Rule prefix | Identifier | Index1 | Index2 |
| 1 | * | 1 | 0 | 7 |
| 2 | 11* | 2 | 0 | 7 |
| 3 | 111111* | 3 | 7 | 7 |
| 4 | 111* | 4 | 4 | 7 |

Exemplary data structure 550 of FIG. 5a consists of exemplary tables 501 and 502, wich were created by using the prefix rules numbered 1 to 3 in Table-2, and prior to the addition of prefix rule number 4 in Table-2. In general, the relevant port identifier fields 508 are inserted into table 501 after comparing the MSBs of each prefix rule to matching bits that constitute the relative addresses in table 501 (3 bits, in this example). For example, none of the (relative, or, sometimes, “offset”) addresses in the address range 507 (addresses ‘000’ to ‘101’, inclusive) matches any prefix rule in Table-2 other than the default prefix rule * (rule number 1 in Table -2), which suggests that the port identifier fields 508 in records field 507 will have the value designated for this exemplary prefix rule (“1”), as shown in table 501 of FIG. 5a.

The prefix rule 11* (rule number 2 in Table-2) can be translated, for table 501 (the first-level table) either to ‘110’ or to ‘111’, which matches the two remaining relative locations/addresses 509 in table 501. Since the latter rule (11*) is associated with port identifier “2” (as shown in Table-2), the value ‘2’ is shown inserted into port identifier fields 508 associated with addresses field 509 (locations, or records/entries, ‘110’ and ‘111’). Since prefix rule 11* is only 2-bit long (L{R}=L(11*)=2), which is bit-wise shorter than C1 (500/1), this rule (11*) terminates at the first-level table (501), which means that the port identifier associated with it (port identifier ‘2’) will not be inserted into a higher level table such as second-level table 502 or third-level table 503. Likewise, according to the exemplary data structure 550, a 4-bit (and up to 6-bit) long prefix rule will terminate at a second-level table such as second-level table (502). This means that the port identifier associated with this prefix rule will not be inserted into a higher level table such as third-level table 503.

Since the exemplary longest prefix rule consists of 6 bits (11111*, prefix rule number 3 in Table-2) and, by definition, field C1 (500/1) can hold only 3 bits, a second-level-table 502 is utilized as well for prefix rule 111111*. Prefix rule (111111*) ‘spans’ over, or ‘covers’, a range of only one record (in this example); that is, its index1=index2=7 (‘7’ being the decimal value of ‘111’, 520 in FIG. 5a). Therefore, the port identifier ‘3’ associated with this rule is shown inserted (521) only in record 111 (520), whereas an “invalid” port ID ‘0’ is shown contained in the port identifier field 512 associated with the other records of second-order table 502. Port IDs ‘0’ in records ‘000’ to ‘110’ (511) indicate that these records are not used by any prefix rule, according to this example. Table 502 is pointed at by a second-level-table identifier y20 (510) because address ‘111 ’ of the record containing identifier y20 (510) may be though of as a prefix of the prefix rule 111111*. Port identifier 3 (521) is shown inserted (521) into the port identifier field 512 associated with address 111 (520) of table 502 because the concatenation of this address (‘111’) and the address ‘111 ’ of table 501 match the prefix rule number 3 in Table-2 (111111*).

Adding prefix rule number 4 in Table-2 (hereinafter “rule 4”, for short) to the exemplary routing data structure 550 shown in FIG. 5a is implemented in the way described hereinafter in connection with FIG. 5b. In this example, L{R}=4, L-3-6, L-6=(−2) and L-9=(−5). Therefore, rule 4 (designated 525 in FIG. 5b) is to be added to a second-level-table (i=2) substantially as described hereinafter, in conjunction with FIGS. 3 and 4. The expansion degree is D=2 and, therefore, the records range covered by rule 4 consists of 2^{D}=2²=4 records (out of eight records, in this example). Since rule 4 is 1111* and ‘*’ may be, in this example, either ‘00’, ‘01’, ‘10’ or ‘11’, this means that rule 4 may cover, or span over, records 100 to 111 of second-level-table 502, which correspond to index1=4 (‘100’) and index2=7 (‘111’).

In a general case, a table to which a new rule, such as rule R=1111*, is to be added is searched for, or, if such a table is not found, a new table is generated for this purpose, in a way exemplified by the flowchart of FIG. 3. Referring again to the exemplary rule number 4 (525, FIG. 5b), since L{R}=L{1111*}=4, the condition set at step 302 of FIG. 3 (with L≦3, according to the example illustrated by FIGS. 5a and 5b) is not met (4>3), which means that the new rule (rule 4) ‘overflows’ to a second-level-table. Therefore, it is required to check whether a second-level table exists in data structure 550 for accommodating for rule 4 (525). At step 304, temp1=‘111’, ‘111’ being bits 0, 1 and 2 of MSB field 513 of prefix rule 525 (FIG. 5b). Temp1=111 points (514) to record 111 of first-level table 501.

According to step 305 of FIG. 3, the content (y20) of the second-level-table identifier field 515 is obtained. Since the obtained content is, in this example, ‘y20’, which is other than Null, a variable p2 (‘2’ indicating a second-level table) is assigned the exemplary value ‘y20’, which is an exemplary base address of the second-level-table 502. Since condition 308 is met (4<6) (with L≦6, according to the example illustrated by FIGS. 5a and 5b), rule 4 is to be added to the second-level-table 502 pointed at (516) by y20 (515). Referring also to FIG. 4, an array IND[, . . . , ]is temporarily generated and allocated (530, FIG. 5b), at step 401, for second-level-table 502, and its entries ‘0’ to ‘7’ are initially set to “1” (“true”), at step 402. That is, IND[0] IND[1]=, . . . , =IND[7]=“1” as schematically illustrated in FIG. 5b.

According to this example, only rule 3 in Table-2 utilizes second-level-table 502; that is, prior to the addition of rule 4 (525). At steps 403 and 404, rule 3 is found in a rules list (not shown) associated with second-level table 502, which is longer than the rule to be added now (rule 4: 1111*). Since rule 3=111111*, it covers only one record (record 111) in second-level-table 502, as shown in FIG. 5a (520). As stated hereinbefore, the expansion degree of rule 3 is D=1 (2⁰), and its index1=index2=7. Accordingly, at step 405, the value of IND[7] is set to “0” (531), to ‘protect’ the port ID identifier of rule 3 from being overridden by the port ID identifier of rule 4. Since rule 3 is the only rule (in table 502) that is longer than rule 4, ‘protection’ loop 407 is terminated and ‘index’=index1=4, according to step 408, and array IND[] (530) is scanned, from index1 to index2; that is, from IND[4] to IND[7], respectively, to identify therein entries in which the initial (‘non-protection’) values ‘1’ were replaced with a (‘protection’) value “0”. Since IND[4]=IND[5]=IND[6]=1, whereas IND[7]=0 (see records field 532, and also 531), a condition that is checked at step 409, the port identifier ‘4’, which is associated with rule 4, is inserted only in records 4 to 6 of records field 519 pointed at by 518, at step 410, even though the span degree (D) of rule 4 covers the entire address range 100 to 111. This is so because whenever two or more prefix rules compete for a certain port identifier field (rules 3 and 4 competing for port identifier field 521 in this example), the longest prefix rule should prevail. Therefore, since record 111 (522, FIG. 5b) in second-level-table 502 is already associated with a prefix rule (111111*) that is longer than rule 4 (1111*), the port identifier field 521 should continue to contain the port identifier associated with prefix rule 111111*. Therefore, only addresses 100 to 110 (inclusive, 523) are eventually updated with the port identifier 4 associated with (the shorter) rule 4, whereas port identifier ‘3’ (521, FIG. 5a) remains ‘protected’, that is, unaffected by the addition of rule 4, as demonstrated by the updated table 502 FIG. 5b. The entries/addresses 519, which are pointed at by 518, are derived from filed 517 of the exemplary rule 525. Unlike MSB field 513, which consists of the maximum number of bits specified for this field (three bits, in this example), the last MSB field 517 is a partial MSB field because it contains only one bit (in this example). The last MSB field 517 may be considered as the LSB field in prefix rule 525. Reference numeral 550′ reflects the data structure 550 of FIG. 5a after the addition of rule 4.

Referring now FIG. 5c, it schematically illustrates an exemplary generalized routing data structure that was generated by using the flowchart of FIGS. 3 and 4. Routing data structure 560 consists of a first-level (‘root’, the highest) table 561, a plurality of second-level tables 562/1 to 562/n and a plurality of third-level tables 563/1 to 563/k. Routing data structure 560 is shown ‘spanning’ over three levels because it is assumed that destination addresses for which port identifiers are to be found in data structure 560, will be parsed to three bits' fields, for example fields 500/1 to 500/3, in the way shown in FIG. 5a. Pursuant to the examples referred to by FIGS. 5a and 5b, each one of the tables of FIG. 5c has eight records, ‘000’ to ‘111’. Each record in the first-level table 561 contains a port identifier 576 (“portID”) and a second-level-table identifier 570, “entry1node.address”. For example, “next1entry.address” (570) in the record whose relative location within first-level table 561 is ‘000’ (572), equals ‘x1’. ‘x1’ is the base address of, and therefore points to (566/1), second-level table 562/n.

Each record in every second-level table contains a port identifier (“portID”) and a third-level-table identifier, “entry2node.address”. For example, next2entry.address (571) in the record, equals ‘x12’. ‘x12’ is the base address of, and therefore points (566/2) to, third-level table 563/k. Likewise, the record ‘001’ (580) of first-level table 561 contains a port identifier (“portID”) 581 and a second-level-table identifier 569, “entry1node.address”. For example, next1entry.address (569) in the record 580 equals ‘x2’. ‘x2’ is the base address of, and therefore points to (565/1), second-level table 562/2. Likewise, the record ‘111’ (582) of first-level table 561 contains a port identifier (“portID”) 573 and a second-level-table identifier 567, “entry1node.address”. For example, next1entry.address (567) in the record 582 equals ‘x3’. ‘x3’ is the base address of, and therefore points to (564/1), second-level table 562/1. Likewise, the record ‘111’ (583) of second-level table 562/1 contains a port identifier (“portID”) 574 and a second-level-table identifier 568, “entry2node.address”. For example, next2entry.address (568) in the record 583 equals ‘x11’. ‘x11’ is the base address of, and therefore points (564/2) to, third-level table 563/1.

Port identifier 573 (in record 582 of table 561) has the value 35, which is associated with prefix rule 111*. Port identifier 574 (in record 583 of table 562/1) has the value 28, which is associated with prefix rule 111111*. Port identifier 575 (in record 584 of table 563/1) has the value 14, which is associated with prefix rule 111111001*. Port identifiers may be assigned a value ‘0’ to indicate that a port number may be found at a next-level table. For example, port identifiers 576 and 581 (in table 561), 590 to 592 (in table 562/1), and 593 and 594 (in table 563/1) have been assigned the value 0.

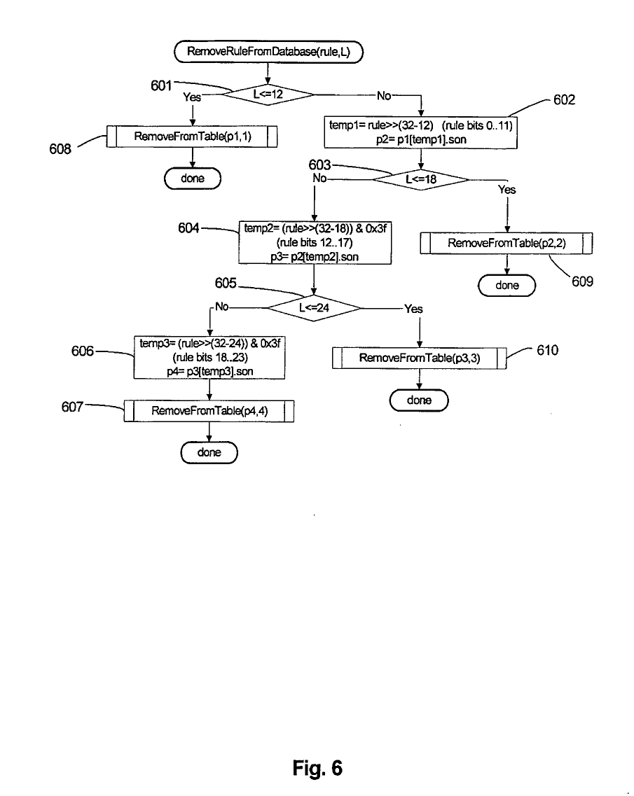

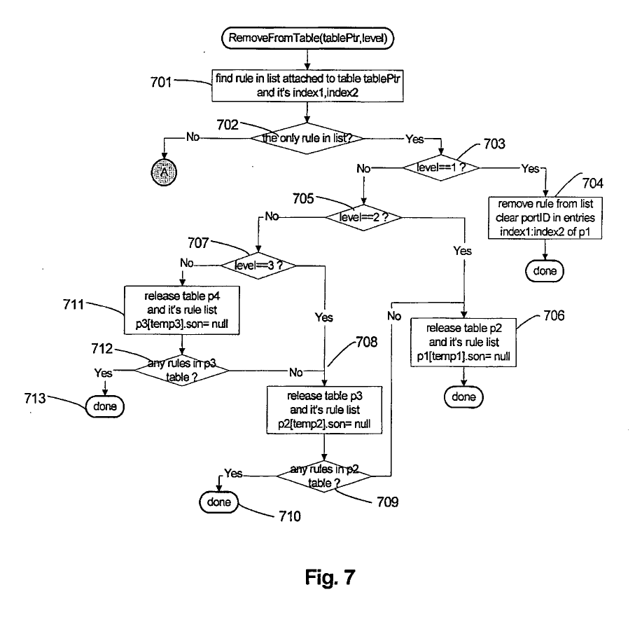

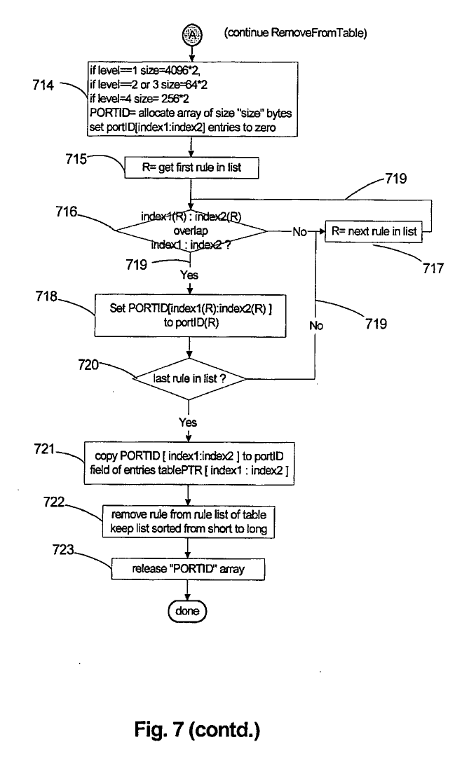

Before an existing rule can be deleted, or removed, from its terminating table in a data structure, the terminating table has first to be found in the routing data structure, as devised by the flowchart of FIG. 6, and then removed as devised by the flowchart of FIG. 7. Regarding a specific prefix rule, the term ‘terminating table’ refers herein to the last table in the prefix rule's path, which may consist of one or more cascading tables. By ‘cascading tables’ is meant herein tables that are serially and logically interlinked, or otherwise serially associated with one another. The association between each two consecutive tables is implemented by a pointer that resides in a first table and ‘points’ to the second table.

Finding a Terminating Table Before Removing from it a Prefix Rule

Referring now to FIG. 6, it shows an exemplary flowchart for finding a table in a search data structure from which a rule may be removed according to some embodiments. If, at step 601, the length of rule to be deleted/removed is equal or shorter than 12, the number of the MSB bits 0 to 11 of the rule (according to some embodiments), this means that the rule resides in, and therefore can be deleted/removed from, the first-level-table, at step 608. Otherwise, (the length of the rule that is to be removed, L{R}, is greater than 12, then a second-level-table in the data structure is accessed, which is included in the ‘rule's path’. Finding the second-level-table, at step 602, means finding the base address of the second-level-table in a record of the first-level-table, the record of the first-level-table being defined, or accessed, by using bits 0 to 11 of the rule R to be deleted/removed.

If, at step 603, the length of the rule that is to be removed, L{R}, is greater than 18 (the number of the MSB bits 0 to 11 plus bits 12 to 17, then a third-level-table in the data structure is accessed, which is included in the ‘rule's path’. Finding the third-level-table, at step 604, means finding the base address of the third-level-table in a record of the second-level-table that is defined by bits 12 to 17 of R.

If, at step 605, the length of the rule that is to be deleted, L{R}, is greater than 24 (the number of the MSB bits 0 to 11 plus bits 12 to 17 plus bits 18 to 24, then a fourth-level-table accessed in the data structure, which is included in the ‘rule's path’. Finding the fourth-level-table, at step 606, means finding the base address of the fourth-level-table in a record of the third-level-table that is defined by bits 18 to 24 of the rule R.

Once the fourth-level-table is found, at step 606, the rule R may be removed from it, at step 607, in the way described in connection with FIG. 7. If condition 601, or 603 or 605 is met, rule R may be removed from the corresponding table, at step 608, or 609 or at step 610, respectively.

Removing a Prefix Rule after Finding Its Terminating Table

Referring now to FIG. 7, it shows an exemplary flowchart for removing a prefix rule from its terminating table that may be found according to the flowchart of FIG. 6. Once the prefix rule's R terminating table is found (using the flowchart of FIG. 6), the rule R is searched for in the rules list associated with, or allocated for, the terminating table, at step 701. index1 and index2 of R define the ‘first-to-last’ records covered by R in the terminating table. If condition 702 is met, meaning that R is the only rule in the rules list, the rule's level is checked. The rule's level is the level at which the rule's path terminates.

If the rule's path terminates at level 1 (condition 703), then, at step 704, R may be removed from the rules list allocated for the terminating first-level-level, and the port identifier associated with R may be cleared from a range of records of the terminating first-level-level that are defined by index1 and index2 of R.

If the rule's path terminates at level 2 (condition 705), then, at step 706, the terminating second-level-table and its rules list may be released, or deleted. The terminating and list may be deleted because, as stated hereinbefore in connection with condition 702, R is the only rule in the table/list and, therefore, there is no point in maintaining an empty table/list. In addition, the second-level-table identifier, which has been pointing at the (now) deleted second-level-table table, is also cleared or assigned a Null value because there is no more second-level-table to point at.

If the rule's path terminates at level 3 (condition 707), then, at step 708, the terminating third-level-table and its rules list may be deleted. The third-level-table identifier in a related second-level-table, which has been pointing at the (now) deleted third-level-table table, is also cleared or assigned a Null value because there is no more related third-level-table to point at. Since the related second-level-table may be a terminating, or an intermediating, table for other rules, this issue is checked out at step 709. If the related second-level-table is not a terminating, or an intermediating, table for other rules, then the related second-level-table and its rules list may be deleted, at step 706. Otherwise (the related second-level-table is a terminating, or an intermediating, table for other rules), the related second-level-table and its rules list are not deleted and the rule's removal process is terminated, at step 710.

If the rule's path terminates at level 4 (condition 707), then, at step 711, the terminating fourth-level-table and its rules list may be deleted. The fourth-level-table identifier in a related third-level-table, which has been pointing at the (now) deleted fourth-level-table table, is also cleared or assigned a Null value because there is no more related fourth-level-table to point at. Since the related third-level-table may be a terminating, or an intermediating, table for other rules, this issue is checked out at step 712. If the related third-level-table is not a terminating, or an intermediating, table for other rules, then the related third-level-table and its rules list may be deleted, at step 708. Otherwise (the related third-level-table is a terminating, or an intermediating, table for other rules), the related third-level-table and its rules list are not deleted and the rule's removal process is terminated, at step 713. If, at step 702, it is found that there is more than one rule in the rules list associated with the R's terminating table (‘R’—the rule to be removed), then it may be required to rearrange the rules in the terminating table and in the list that remains after the removal of R.

At step 714, a new array, PORTID[], is temporarily created and allocated for the terminating table. The size of the array (in bytes) may be twice the size of the terminating table, because two bytes may be assigned in each entry of the PORTID[, . . . , ] for each record in the terminating table. For example, if the path of the rule to be removed terminates at level 1, then, assuming that the first-level-table has 2¹²=4,096 records, the size of PORTID[] will be 4,096*2 bytes. Likewise, assuming that the path of the rule to be removed terminates at level 2 or 3, then, assuming also that the 2 or third-level-table has 2⁶=64 records, the size of PORTID[] will be 64*2 bytes. Then, at step 715, a first prefix rule (R1) in the rules list associated with the terminating table is searched for.

Once R1 is found in the list, it is checked whether there is an overlap, in whole or in part, between records covered by R1 and records covered by R, the prefix rule to be removed. Overlapping records are records that are commonly used by both R1 and R. As variously stated hereinbefore, the range of records in a terminating table that are covered by any specific rule is defined by the index1 and index2 of that specific rule.

Accordingly, at step 716, the records range defmed by index1 and index2 of R1 is compared to the records range defmed by index1 and index2 of R. If there is no overlap at all between the two records ranges, then the next rule in the list, R2, is searched for, at step 717. If, however, there is an overlap (716), this means that the port identifier of R, which currently occupies the overlapping records, should be substituted with, or overridden by, the port identifier of R2, a substitution that is preceded by step 718. If index1=0 and index2=7 for R, and index1=4 and index2=7 for R2 (for example), then records 4 to 7, inclusive, are considered overlapping records in the terminating table (‘terminating’—in respect of the rule to be removed). If there are additional rules in the rules list (R3, R4, . . . , etc.), then PORTID[] ‘loading’ loop 719, which includes steps 717, 716 and 718, is repeated for each such additional rule. According to some embodiments, the rules in the rules list are sorted from the shortest rule to the longest rule such that whenever loop 719 is repeated with a longer rule, the port identifier of the longer rule overrides the port identifier of the shorter rule in the corresponding entry, or entries, of PORTID[].

After visiting the last rule in the list, a condition that is checked at step 720, PORTID[] may include, at this stage, port identifiers of the longest rule(s) available. The next step is to copy the content of the entries of PORTID[], which entries are defined by index1 and index2 of R, into the port identifier field of the records of the terminating table, which records are also defined by index1 and index2 of R, as suggested by step 721. Once step 721 is completed, the rule that was removed from the table may be, according to step 722, removed from the rules list associated with that table, and the rules list may be resorted from the shortest rule to the longest rule, either now or before the removal of another prefix rule. Once the rule removal process is completed, the temporary array PORTID[] may be erased, at step 723.

Changing a Rule

Changing a rule means either changing the port identifier associated with that rule or changing the prefix rule leading to a given port identifier. According to some embodiments, changing a rule may be performed by removing the rule and adding a new rule in its stead, which reflects the change.

An Example for Deleting/Removing a Prefix Rule from a Routing Data Structure

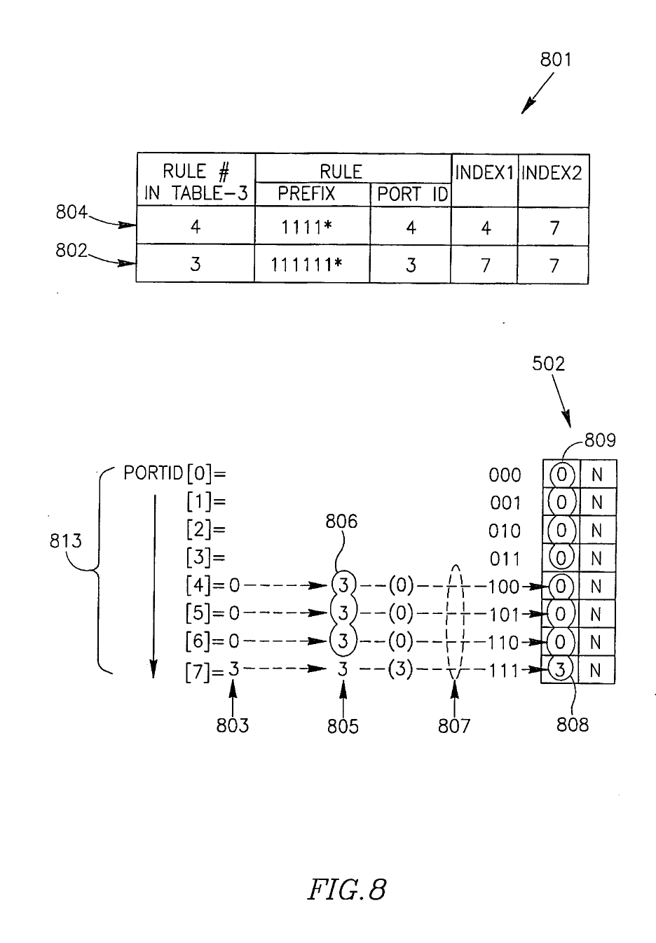

Referring now to FIG. 8, it exemplifies removal of a prefix rule from exemplary search data structure 550′ (FIG. 5b) according to the exemplary flowcharts of FIGS. 6 and 7. The removal of the exemplary prefix rule 4 (802) will be explained in conjunction with FIGS. 5b, 6 and 7. Since the length of rule 4, L{R}, equals 4, the condition 601 in FIG. 6 (with L≦3, according to the demonstration) is not met. Therefore, according to step 602, temp1=111 (see bits field 513 in FIG. 5b) will be used to point (514, FIG. 5b) to a record of first-level-table 501, in which a second-level-table identifier y20 (515, FIG. 5b) may be found. Since L{R}=4, condition 603 is met (with L≦3+3=6, according to the demonstration), which means that rule 4 is expected to reside within, and therefore to be removed from, a second-level-table (502, FIG. 5b) that is pointed at by the second-level-table identifier y20 (515, FIG. 5b), with which rules list 801 is associated.

After the addition of rule 4 to table 502, table 502 includes port identifiers ‘3’ and ‘4’, as shown in FIG. 5b, which are associated with rules 3 and 4, respectively. Therefore, rules list 801 includes only rule 4 and rule 3, which also terminate at the second-level-table 502. Rules list 801 may contain, per each listed rule, the prefix (for example—prefix 1111 for rule 4), the port identifier (portED) relating to the prefix rule ((for example portID=4 for rule 4), and index1 and index2 of the prefix rule. For example, entry 802 in list 801, which relates to rule 3, contains the prefix 11111, the portID associated with it is ‘3’, and its index1=7 and index2=7.

Once table 502 has been found (by using the flowchart of FIG. 6), rule 4 is removed from it by using the flowchart of FIG. 7, as follows. At step 701, rule 4 is found (804) in rules list 801. Since rule 4 is not the only rule in rules list 801; that is, the list includes an additional rule (rule 3, 802 in FIG. 8), the condition 702 (FIG. 7) is not met. Therefore, an array PORTID[] (symbolically designated as 813) is temporarily created, at step 714. Since second-level-table 502 has eight records, the number of bytes of PORTID[] is 8*2=16 bytes. Next, entries 4 to 7, inclusive, of PORTID[] (813) are assigned an initial value “0” (803), which entries correspond to index1=4 and index2=7 of rule 4 (804).

Rule 3 is visited (802) in list 801, and its indexes range 7 (index1) to 7 (index2) is compared to indexes range 4 to 7 of rule 4 (804), at step 716. Then, at step 718, entry 7 of PORTID[] (813), that is PORTID[7], is assigned a value ‘3’ (805), which is the port identifier associated with rule 3 (802), according to this example. If index1 of rule 3 was ‘4’ (instead of ‘7’), entries 4 to 6 of PORTID[] were assigned the value ‘3’ as well (806). Since rule 3 is, in this example, the last rule visited in list 801, then, according to step 720, PORTID[] (813) is not updated any further, which ‘leaves’ array PORTID[] 813 in the following condition: PORTID[4]=PORTID[5]=PORTID[6]=0, and PORTID[7]=3. In general, it may be said that each rule in a rules list, except the rule that is to be removed from that list, ‘contributes’ its port identifiers to the array (PORTID[]), by having its port identifiers inserted into the respective entries of the array, based on each individual rule's index1 and index2. This way, the port identifiers occupying one or more records of the table will be occupied by port identifiers associated with other prefix rules, or by the reserved value ‘0’. Since, per each table, the longest prefix rule in this table should prevail, its port identifiers will override the port identifier of the removed prefix rule, and also port identifiers of shorter prefix rule(s), that is, if such prefix rule(s) exist(s).

At step 721, the content of entries 4 to 7 of PORTID[] (805, without factoring in the figures designated 806) is copied (the copying operation being symbolically designated by reference numeral 807) to the port identifier field 808 of the respective records 4 to 7 of second-level-table 502. After the copying operation, table 502 becomes the original table shown in FIG. 5a, which is the table's state prior to the addition of rule 4. Reference numeral 809 designates port identifier fields that were not affected by the removal of rule 4, whereas reference numeral 808 designates affected port identifier fields.

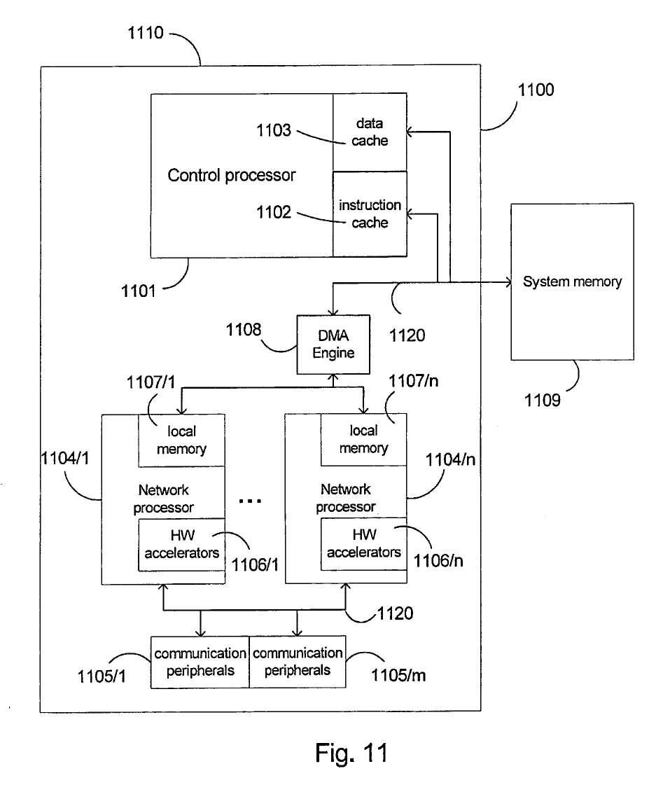

Referring now to FIG. 9, it shows an exemplary search flowchart for searching for a prefix rule in a routing data structure, according to some embodiments. For the sake of the example, it is assumed that a data packet has arrived to the router whose destination address is a 32-bit long (901). It is also assumed that the routing data structure resides in an external/system memory (1109, FIG. 11) is accessible by a network controller (1104, FIG. 11) via a direct access memory (“DMA”) engine (1108, FIG. 11), as by link 1120. A detailed description of the functionality of network controller 1104, memory 1109 and DMA engine 1108 is given hereinafter, in connection with FIG. 11. In order to save communication, processing and memory resources, network controller 1104 does not handle the 32-bit destination address in one session, because it may occur that the sought prefix rule is relatively short, say 4 bit-long (for example), and, therefore, there will be no need to process the entire destination address. Network controller 1104 does not retrieve the 32-bit destination address (via DMA engine 1108) as a whole but, rather, network controller 1104 may start by fetching from system memory 1109 a data block that contains the destination address. Then, network controller 1104 may handle the destination address by taking fields, or partial fields of the most significant bits of the destination address, one field or partial field at a time, starting from the most significant bit towards the least significant bit of the destination address. For example, if the destination address is the destination address 1000 (FIG. 10), network controller 1104 will first handle a first bits' field C1 (1001), which consists of the 12 MSBs of the destination address 1000 (in this example). This is done at step 902.

More specifically, at step 902, network controller 1104 may request DMA engine 1108 to get for it a first port identifier and a second-level table identifier from a record of the first-level table of the data structure stored in system memory 1109. The base address of the first-level table (“levellnode”) is known in advance, as it is the ‘root’, or highest level, table. The relative location of the record within the first-level table may now be determined by, or is associated with, the first bits' field (in this example 12 bits, bit 0 to bit 11) of the DA, which may be, for example, the bits field C1 (1001) of FIG. 10. After some delay (903), network controller 1104 may receive from DMA engine 1108 a requested data block, from which the network processor may extract a first port identifier (“portID=node1entry.portID”) and the next (now the second)-level table identifier (“address=node1entry.address”).

If the second-level-table identifier equals ‘0’ (“Null”), a condition that is checked at step 905, this indicates that the prefix rule is not longer than (12 bits, in this example). This means that the port identifier found in the record of the first-level-table (at step 904); that is, node1entry.portID, is determined (906) as the longest prefix for the destination address (DA). However, if the second-level-table identifier has a value other than “Null” (at step 905), then this indicates that a second-level table has to be found because the prefix rule is longer than 12 bits, in this example.

At step 907, network controller 1104 may request DMA engine 1108 to get for it a second port identifier and a third-level table identifier from a record of the second-level table of the data structure stored in system memory 1109. The base address (“address”) of the second-level table has already been obtained at step 904 (“address=node1entry.address”). The relative location of the record within the second-level table may now be determined by, or is associated with, the next (second) bits' field (in this example 6 bits, 12 to 17) of the DA, which may be, for example, the bits field C2 (1002) of FIG. 10. After some delay (908), network controller 1104 may receive from DMA engine 1108 an additional data block, from which the network processor may extract a second port identifier (“portID=node2entry.portID”) and a next (now the third)-level-table identifier (“address=node2entry.address”).

If the third-level-table identifier equals ‘0’ (“Null”), a condition that is checked at step 910, this indicates that the prefix rule is not longer than (12+6=18 bits, in this example). This means that the port identifier found in the record of the second-level-table (at step 909); that is, node2entry.portID, is determined (911) as being associated with the longest prefix for the destination address (DA); that is, provided that node2entry.portID has a non-zero value. However, if the third-level-table identifier has a value other than “Null” (at step 910), then this indicates that a third-level table has to be found because the prefix rule is longer than 18 bits, in this example.

At step 912, network controller 1104 may request DMA engine 1108 to get for it a third port identifier and a fourth-level table identifier from a record of the third-level table of the data structure stored in system memory 1109. The base address (“address”) of the third-level table has already been obtained at step 909 (“address=node2entry.address”). The relative location of the record within the third-level table may now be determined by, or is associated with, the next (third) bits' field (in this example 6 bits, 18 to 23) of the DA, which may be, for example, the bits field C3 (1003) of FIG. 10. After some delay (913), network controller 1104 may receive from DMA engine 1108 a requested additional data block, from which the network processor may extract third port identifier (“portID=node3entry.portID”) and the next (now the fourth)-level-table identifier (“address=node3entry.address”).

If the fourth-level-table identifier equals ‘0’ (“Null”), a condition that is checked at step 915, this indicates that the prefix rule is not longer than (12+6+6=24 bits, in this example). This means that the port identifier found in the record of the third-level-table (at step 914); that is, node3entry.portID, is determined (916) as being associated with the longest prefix for the destination address (DA); that is, provided that node3entry.portID has a non-zero value. However, if the third-level-table identifier has a value other than “Null” (at step 914), then this indicates that a fourth-level table has to be found because the prefix rule is longer than 24 bits, in this example.

At step 917, network controller 1104 may request DMA engine 1108 to get for it a fourth port identifier from a record of the fourth-level table of the data structure stored in system memory 1109. The base address (“address”) of the fourth-level table has already been obtained at step 914 (“address=node3entry.address”). The relative location of the record of the fourth-level table may now be determined by, or is associated with, the next (in this example the fourth and last) bits' field (in this example 8 bits, 24 to 31) of the DA. The fourth (and last) bits' field may be, for example, the bits field C4 (1004) of FIG. 10. After some delay (918), network controller 1104 may receive from DMA engine 1108 requested additional data block, from which the network processor may extract a fourth port identifier (“port ID=node4entry.portID”). If the fourth port identifier (node4entry.portID) does not equal ‘0’ (step 919), this port identifier (node4entry.portID) is determined (920) as being associated with the longest prefix for the destination address (DA). If the fourth port identifier (node4entry.portID) equals ‘0’, then the last non-‘0’ port identifier is determined as being associated with the longest prefix for the destination address (DA).

Referring again to FIG. 10, it demonstrates searching in an exemplary routing data structure for a port identifier for an exemplary 32-bit destination address 188.177.71.2 (1000) (the binary representation of which is 10111100.10110001.01000111.00000010) partitioned into four exemplary MSB fields, C1 to C4. C1 may be 12-bit long, for example, C2 may be 6-bit long, for example, C3 may be 6-bit long, for example, and C4 may be 8-bit long, for example. Accordingly, four tables of ²_{¹²}_{=4,096} (4K), ²_{⁶}=64, ²_{⁶}=64 and ²_{⁸}=256 records may theoretically be associated with C1, C2, C3 and C4. Also shown in FIG. 10 is a search data structure 1050 which was generated by using the two prefix rules #1 (1018) and 2 (1019) specified in Table-3 and in accordance with the exemplary flowcharts of FIGS. 3 and 4. Exemplary First-level table 1005 and exemplary second-level table 1009 constitute exemplary cascading tables, because the two tables are associatively interconnected. More specifically, a next-table identifier 1007 in table 1005 points (1008) to table 1009.

TABLE 3

| | | Port |
|---|---|---|
| Rule # | Prefix Rule | Identifier |
| 1 | 101111001* | 9 |
| 2 | 101111001011000* | 12 |

Looking for a port identifier for destination address 1000 in data structure 1050 involves ‘following’ the longest possible prefix rule in the routing data structure 1050, which ‘leads’ to that port identifier. A packet may be received at the router with a destination address 1000.

The base address of the first-level table 1005 (“level1node”) is known in advance because it is the root table which represents the first, highest, search/lookup level. According to step 902 of FIG. 9, network controller 1104 may request DMA engine 1108 to get for it a first port identifier and a second-tevel table identifier from a record of the first-level table 1005 of the data structure 1050 stored in system memory 1109. Since the first bits field (C1, 1001) consists of 12 bits, the first-level table 1005 contains 4,095 entries, or records, numbered 0 (1010) to 4,095 (1011). The relative location of the record within the first-level table 1005 may, therefore, be determined by, or is associated with, the bits field C1 (1001), which is the first bits' field (in this example 12 bits, 0 to 11) of DA 1000. More specifically, the relative location of the record within the first-level table is 3,019 (1014), which is the decimal value of the first bits' field ‘101111001011’. After some DMA delay (according to step 903, FIG. 9), network controller 1104 may receive from DMA engine 1108 the requested port identifier node1entry.portID (1006, node1entry.portID=9, in this example) and the next (now the second)-level-table identifier node1entry.address (1007, node1entry.address=x21). ‘x21’ is the base address, or a pointer, pointing (1008) to the second-level table 1009.

Since the second-level-table identifier (1007) has a value other than “Null”, namely it has a non-Null value x21 (node1entry.address=x21), then, this indicates that a second-level table has to be found because the prefix rule is longer than 12 bits, in this example. According to step 907, network controller 1104 may request DMA engine 1108 to get for it a second port identifier and a third-level table identifier from a record of the second-level table 1009 of the data structure 1050 stored in system memory 1109. The base address (“address”) of the second-level table has already been obtained (address=node1entry.address=x21).

Since the second bits field (C2, 1002) consists of 6 bits, the second-level table 1009 contains 64 entries, or records, numbered 0 (1012) to 63 (1013). The relative location of the record within the second-level table 1009 may, therefore, be determined by, or is associated with, the bit field C2 (1002), which is the second bits' field (in this example 6 bits, 12 to 17) of DA 1000. More specifically, the relative location of the record within the second-level table is 5 (1017), which is the decimal value of the second bits' field (1002) ‘0001011’. After some DMA delay (according to step 903, FIG. 9), network processor 1104 may receive from DMA engine 1108 a requested data block, from which the network processor 1104 may extract the port identifier node2entry.portD (1015, node2entry.portID=12, in this example) and the next (now the third)-level-table identifier node2entry.address (1016, node2entry.address=Null).

Since the third-level-table identifier (1016) has a “Null” value, (node2entry.address=N), then, this indicates that the last, terminating, table (or terminating node) has been visited, and no third-level table exists because the longest prefix rule is not longer than 12+6=18 bits, in this example. Therefore, the value of the node2entry.portID; namely the value 12 (1015), is returned as the port identifier that matches the longest prefix rule 2 (1019).

At times, it may be desired to update (find, add, remove or change a specific prefix rule in) the routing data structure. In order to allow updating data structures, a rule list is created for each table in the data structure. Each rule list may include data that relates to every rule associated with the respective table. For each rule, the list may contain at least the rule itself (“R”), for example (R=) 1101*, the rule's length, (“L{R}”), in number of bits, for example L{1101*}=4 (bits), the rule's expansion degree “(D”), which is the number of consecutive records in the last table where the rule ‘terminates’, index1 and index2, which are the starting and ending records of D. Before addition of a new rule to the search data structure takes place, a table has to be first found in the routing data structure, to which the new rule will be added. If such a table does not yet exist, it has first to be created in the ‘proper place’ in the data structure. It is assumed that destination addresses are partitioned into fields such as to the exemplary fields shown in FIG. 10. However, the flowcharts of FIGS. 3, 4, 6, 7 and 9 can be employed on different partitions of destination addresses, after making the corresponding adaptation.

Referring now to FIG. 11, it schematically illustrates a system according to an exemplary embodiment. Control processor 1101 (sometimes referred to as a “host”) is responsible for operating the system 1100 as a whole and, in particular, for operating higher-level protocol stacks, initialization code(s), control and management applications. Control processor 1101 may be based on a high-performance general-purpose architecture and it may include instruction and data caches (1101 and 1103, respectively). Caches 1102 and 1103 hold, among other things, the most recently and most frequently used instructions and data variables. Control processor 1101 executes the programs associated with the generation and update of the routing data structure, as described in connection with the flowcharts of FIGS. 3, 4, 6 and 7. Network processor 1104 executes the programs associated with the searches, as described in connection with the flowchart of FIG. 9. Network processor 1104 directly handles the incoming data packets. One or more network processors 1104 usually run applications relating to lower level communication software, which handles level-2, and other types of, communication protocols. The lower level communication software also handles some aspects of ingress and egress data processing. Network processor 1104 may have a direct access to the communication peripherals 1105/1 to 1105/m, and to hardware accelerators 1106/1 to 1106/n.

Network processor 1104 typically has an internal fast memory 1107. Network processor 1104 may access system memory 1109 bus (1120) only via direct memory access (“DMA”) engine 1108. However, accessing external memory 1109 by network processor 1104 often results in relatively long latencies and significant processing time. Network processor 1104 may not have to wait until a DMA access is completed, but, rather, network processor 1104 may perform other tasks while the DMA is accessed. For example, network processor 1104 may run instruction codes relating to the packets' reception and transmittal operations performed by other peripheral(s). Network processor 1104 may also run (while the DMA is accessed) instruction codes relating to queue scheduling, data buffer allocation or de-allocation. Tasks handling IP lookups have to wait for the result of the DMA before they can perform another task, or continue with the task at hand. According to some embodiments, the search tables constituting the routing data structure are stored in system memory 1109, and the routing data structure is optimized in respect of the number of times that memory 1109 is accessed by network processors 1104.

According to some embodiments, a task performed by system 1100 is handled either via a fast path or via a slow path. The fast path, which is handled by network processor 1104, essentially encompasses all the activities done on the majority of data packets. Such activities may be associated, for example, with receiving data cells and/or data packets from a peripheral communication (1105) and storing them in system memory 1109; allocating and de-allocating data buffers, which are used for storing received packets; parsing protocol headers; classifying packets; data traffic policing; forwarding and queuing packets; scheduling output queues and sending data cells and/or data packets to peripherals 1105. Data packets may roughly be divided into two main fields. Packets belonging to a first main field are intended to be routed by system 1100 to a third party; that is, to a party other than system 1100. Packets belonging to the second main field are intended for the control processor 1101, in which case the control processor 1101 is the final destination for these packets. Therefore, the term ‘classification of packets’ refers, in this disclosure, to an identification phase during which phase a determination is made (typically by network processor 1104) as to the main field a received packet belongs to. The slow path, which is handled by control processor 1101, encompasses activities such as: initializations; generating and updating the routing data structure; memory management; management protocols; control protocols; errors handling and complex processing that may be needed for a small number of special packets.

In operation, a data packet may be received at communication peripherals 1105 and forwarded to a network processor 1104, over bus 1120. Then, a copy of small fragment of the packet may be stored in local memory 1107, whereas the entire packet is assembled and stored in system memory 1109. Network processor 1104 may get from memory 1109, via DMA engine 1108 and link 1120, portions of the received packet. If a decision is reached by the network processor 1104 that the data packet should be relayed to another router, then network processor 1104 may search in the routing data structure, which is stored in system memory 1109, for the longest prefix rule suitable for the received data packet. The decision to relay the data packet to another router is made by network processor 1104 based on the port identifier that is found in the data structure and associated with the longest prefix rule suitable for the received data packe.

Once network processor 1104 finds the longest matching prefix rule suitable for the received data packet, and hence the related port number to which the data packet should be sent, network processor 1104 may enable that port and send the data packet to the enabled port. Control processor 1101 may update the routing data structure in system memory 1109 while network processor 1104 continues to receive and handle, ‘on-the-fly’, additional packets, via communication peripherals 1105/1 to 1105/m and via bus 1120.

A major concern in using any routing data structure is the ability to update the routing data structure without interfering with the reception of data packets at communication peripherals 1105 and without interfering with the look-up done by the network processor 1104. Since both the control processor 1101 and the network processor(s) 1104 utilize the same routing data structure, they are designed in a way that control processor 1101 may update data structures substantially at the same time the network processor 1104 performs the IP address lookup. The updates and concurrent processing may be substantially performed without jeopardizing the integrity of the routing data structure because control processor 1101 handles the updates in such a way that the routing data structure (the search multibit trie) remains correct and coherent substantially at all times.

The elements enclosed by dotted box 1110 may be implemented as an apparatus, or as a one-microelectronic chip, such as in the form of a VLSI device. System memory 1109 may be implemented as a separate chip/chips, due to the relatively large memory capacity required for storing therein multiple search tables (of a routing data structure), rules lists that are associated with the multiple tables and arrays that are temporarily generated by the control processor 1101 while an updating process occurs.

The system disclosed herein (system 1100) provides a practical and efficient search solution, because the two tasks, of generating and updating the data structure, and searching for prefix rules, are each done by a different processor, as explained hereinbefore. The searches are done by a cheap and readily available network processor(s) (1104), and in the worst case the number of processor's cycles required per search is about 50 cycles, and up to 4 memory accesses (accesses to system memory 1109) may be required (for four-level data structure), with reasonable memory consumption and reasonable update complexity. The algorithms disclosed herein may be tailored to, or adapted for, a broad spectrum of communication processor hardware designs.

It is noted that partitioning rules and destination addresses to three and four bit fields, or columns, with their bit-wise lengths, are only meant to exemplify the method disclosed herein. Of course, the method is to be construed as a generalized method that can be employed on different numbers of bit fields with different bit-wise fields' length.

While certain features of the disclosure have been illustrated and described herein, many modifications, substitutions, changes, and equivalents will now occur to those skilled in the art. It is, therefore, to be understood that the appended claims are intended to cover all such modifications and changes as fall within the true spirit of the disclosure.

What is claimed is:

1. A method of generating a data structure for routing Internet protocol packets, which data structure initially including a first-level table, comprising:
a) adding a prefix rule to said first-level table if the terminating level of said prefix rule equals one;
b) creating one or more cascading tables if the terminating level of said prefix rule is greater than one, such that the last created table is a terminating table for said prefix rule, and
c) adding said prefix rule to said terminating table.

2. The method of claim 1, wherein creating the one or more cascading tables, comprises:
repeatedly creating a next-level table while in each repetition a corresponding next-level-table identifier populates a record of the previous-level table that is pointed at by a next most significant bits field of the prefix rule, until a terminating table for the prefix rule is created.

3. The method of claim 2, wherein the addition comprises:
populating one or more records of the terminating table with the port identifier of the prefix rule being added if said prefix rule is the longest prefix rule pertaining to said one or more records; said one or more records being pointed at by the last field, or last partial field, of the most significant bits of the prefix rule being added.

4. The method of claim 1, further comprising updating the routing data structure, the updating comprising repetition of steps a) to c) of claim 1.

5. The method of claim 3, further comprising creating a rule list for each created table, for listing all rules terminating in a respective table.

6. The method according to claim 5, wherein the updating further comprises removal of a prefix rule from the data structure.

7. The method according to claim 6, wherein the removal of a prefix rule comprises: locating a terminating table of said prefix rule and removing said prefix rule from said terminating table and associated rule list; the locating being guided by corresponding fields, or partial fields, of most significant bits of said prefix rule.

8. The method according to claim 7, wherein the removal further comprises:
substituting the removed prefix rule in one or more records of the terminating table with other prefix rules terminating at said terminating table, said one or more records being pointed at by the last field, or partial field, of the most significant bits of said prefix rule, the substitution comprises, for each one of said one or more records, inserting the longest prefix rule relevant for the record.

9. The method according to claim 1, wherein the Internet protocol packet conforms to the IPv4 protocol.

10. The method according to claim 1, wherein the routing data structure consists of four search levels.

11. The method according to claim 10, wherein the first, second, third and fourth field of most significant bits of a prefix rule includes 12 bits, 6 bits, 6 bits and 8 bits, respectively.

12. The method according to claim 4, wherein the generation and update of the data structure is performed by a control processor, which control processor storing the generated data structure in an external system memory, and the routing of Internet protocol packets is performed by a network processor; which network processor coupling to at least one direct memory access engine for requesting an access to said external system memory to obtain at least the header of a received packet, or a portion thereof; said network processor extracting a destination address from said header and partitions the destination address into most significant bits fields, or partial fields, one field/partial field at a time, for guiding the search in the routing data structure for a port identifier to which the received packet should be sent.

13. A method of routing an Internet protocol packet by use of a routing data structure, comprising:
associating a first field of the most significant bits of a destination address of the packet with a record of a first-level-table, wherein the record of the first-level-table includes either a first port identifier and/or a second-level-table identifier, and using the first port identifier for routing the packet in the absence of a second-level-table identifier.

14. The method according to claim 13, further comprising:
associating a second field of the most significant bits of the destination address with a record of a second-level-table identified by the second-level-table identifier, wherein the record of the second-level-table includes either a second port identifier and/or a third-level-table identifier, and using the second port identifier, or in its absence the first port identifier, for routing the packet in the absence of a third-level-table identifier.

15. The method according to claim 15, further comprising:
associating a third field of the most significant bits of the destination address with a record of a third-level-table identified by the third-level-table identifier, wherein the record of the third-level-table includes either a third port identifier and/or a fourth-level-table identifier, and using the third port identifier, or in its absence the second port identifier, or in its absence the first port identifier, for routing the packet in the absence of a fourth-level-table identifier.

16. The method according to claim 15, further comprising:
associating a fourth field of the most significant bits of the destination address to a record of a fourth-level-table identified by the fourth-level-table identifier, wherein the record of the fourth-level-table may include a fourth port identifier, and using the fourth port identifier, or in its absence the third port identifier, or in its absence the second port identifier, or in its absence the first port identifier, for routing the packet.

17. The method according to claim 13, wherein the Internet protocol packet conforms to the IPv4 protocol.

18. The method according to claim 13, wherein the routing data structure consists of four search levels.

19. The method according to claim 18, wherein the first, second, third and fourth field of most significant bits of a prefix rule includes 12 bits, 6 bits, 6 bits and 8 bits, respectively.

20. An apparatus for routing an internet protocol packet, comprising:
a control processor for generating and storing in an external system memory a routing data structure that includes at least a first-level table, and for updating said routing data structure;
an input/output ports unit for receiving a packet via an input port and forwarding said packet via an output port;
one or more direct memory access engines for allowing an access to data stored in said external system memory; and
a network processor coupled to said input/output ports unit to receive therefrom packets and to forward there through packets, said network processor forwarding received packets to said external system memory; said network processor coupling to at least one direct memory access engine for requesting an access to said external system memory to obtain at least the packet's header or a portion thereof; said network processor extracts a destination address from said header and partitions the destination address to most significant bits fields, or partial fields, one field/partial field at a time, for guiding the search in the routing data structure for a port identifier to which the received packet should be sent.

21. The apparatus of claim 20, wherein the control processor performs the generation by:
a) adding a prefix rule to the first-level table if the terminating level of said prefix rule equals one;
b) creating one or more cascading tables, if the terminating level of said prefix rule is greater than one, such that the table last created is a terminating table for said prefix rule, and
c) adding said prefix rule to said terminating table.

22. The apparatus of claim 21, wherein the control processor performs the addition by:
populating one or more records of the terminating table with the prefix rule being added if said prefix rule is the longest prefix rule pertaining to said one or more records, said one or more records being pointed at by the last field, or partial field, of the most significant bits of the prefix rule being added.

23. The apparatus of claim 21, wherein control processor creates the one or more cascading tables and add the prefix rule to the terminating table by:
repeatedly creating a next-level table while in each repetition, a corresponding next-level-table identifier populates a record of the previous-level table, which is pointed at by a further most significant bits field of the prefix rule, until a terminating table for the prefix rule is created; and adding said prefix rule to record(s) of the terminating table, said record(s) is/are pointed at by a corresponding most significant bits field, or partial field, of the prefix rule.

24. The apparatus of claim 21, wherein the network processor performs the routing of the packet by:
associating a first field of the most significant bits of a destination address of the packet with a record of a first-level-table, wherein the record of the first-level-table includes either a first port identifier and/or a second-level-table identifier, and using the first port identifier for routing the packet in the absence of a second-level-table identifier;
associating a second field of the most significant bits of the destination address with a record of a second-level-table identified by the second-level-table identifier, wherein the record of the second-level-table includes either a second port identifier and/or a third-level-table identifier, and using the second port identifier, or in its absence the first port identifier, for routing the packet in the absence of a third-level-table identifier;
associating a third field of the most significant bits of the destination address with a record of a third-level-table identified by the third-level-table identifier, wherein the record of the third-level-table includes either a third port identifier and/or a fourth-level-table identifier, and using the third port identifier, or in its absence the second port identifier, or in its absence the first port identifier, for routing the packet in the absence of a fourth-level-table identifier; and
associating a fourth field of the most significant bits of the destination address to a record of a fourth-level-table identified by the fourth-level-table identifier, wherein the record of the fourth-level-table may include a fourth port identifier, and using the fourth port identifier, or in its absence the third port identifier, or in its absence the second port identifier, or in its absence the first port identifier, for routing the packet.

25. The apparatus of claim 20, wherein the control processor, network processor, direct memory access engine, hardware accelerator and communication peripherals are implemented as one microelectronic chip.

26. A system for routing an internet protocol packet, comprising:
a system memory for storing therein a set of prefix rules;
a control processor coupled to said system memory for generating and storing in said system memory, and thereafter for updating, a routing data structure;
input/output ports unit for receiving a packet via an input port and forwarding said packet via an output port;
one or more direct memory access engine for allowing an access to data stored in said external system memory; and
a network processor coupled to said input/output port unit to receive therefrom packets, and to forward there through packets, said network processor forwarding received packets to said external system memory; said network processor coupling to at least one direct memory access engine for requesting an access to said external system memory to obtain at least the packet's header or a portion thereof; said network processor extracts a destination address from said header and partitions the destination address to most significant bits fields, or partial fields, one field/partial field at a time, for guiding the search in the routing data structure for a port identifier to which the received packet should be sent.

27. The system of claim 26, wherein the control processor performs the generation by:
a) adding a prefix rule to the first-level table if the terminating level of said prefix rule equals one;
b) creating one or more cascading tables, if the terminating level of said prefix rule is greater than one, such that the table last created is a terminating table for said prefix rule, and
c) adding said prefix rule to said terminating table.

28. The system of claim 27, wherein the control processor performs the addition by:
populating one or more records of the terminating table with the port identifier associated with the prefix rule being added if said prefix rule is the longest prefix rule pertaining to said one or more records; said one or more records being pointed at by the last field, or partial field, of the most significant bits of the prefix rule being added.

29. The system of claim 27, wherein the control processor creates the one or more cascading tables and adds the prefix rule to the terminating table by:
repeatedly creating a next-level table while in each repetition, a corresponding next-level-table identifier populates a record of the previous-level table, which is pointed at by a further most significant bits field of the prefix rule, until a terminating table for the prefix rule is created; and adding said prefix rule to record(s) of the terminating table, said record(s) is/are pointed at by a corresponding most significant bits field, or partial field, of the prefix rule.

30. The system of claim 27, wherein the network processor performs the routing of the packet by:
associating a first field of the most significant bits of a destination address of the packet with a record of a first-level-table, wherein the record of the first-level-table includes either a first port identifier and/or a second-level-table identifier, and using the first port identifier for routing the packet in the absence of a second-level-table identifier,
associating a second field of the most significant bits of the destination address with a record of a second-level-table identified by the second-level-table identifier, wherein the record of the second-level-table includes either a second port identifier and/or a third-level-table identifier, and using the second port identifier, or in its absence the first port identifier, for routing the packet in the absence of a third-level-table identifier;
associating a third field of the most significant bits of the destination address with a record of a third-level-table identified by the third-level-table identifier, wherein the record of the third-level-table includes either a third port identifier and/or a fourth-level-table identifier, and using the third port identifier, or in its absence the second port identifier, or in its absence the first port identifier, for routing the packet in the absence of a fourth-level-table identifier; and
associating a fourth field of the most significant bits of the destination address to a record of a fourth-level-table identified by the fourth-level-table identifier, wherein the record of the fourth-level-table may include a fourth port identifier, and using the fourth port identifier, or in its absence the third port identifier, or in its absence the second port identifier, or in its absence the first port identifier, for routing the packet.
